(19) United States
(12) Patent Application Publication
(10) Pub. No.: US 2009/0021677 A1
(43) Pub. Date: Jan. 22, 2009

(54) COMPOSITE RETARDATION PLATE, ITS PRODUCTION METHOD, COMPOSITE OPTICAL MEMBER AND LIQUID CRYSTAL DISPLAY

(75) Inventors: Norimasa Nakagawa, Ehime (JP); Yuichiro Kunai, Ehime (JP); Jun Furukawa, Ehime (JP)

Correspondence Address: SUGHRUE MION, PLLC, 2100 PENNSYLVANIA AVENUE, N.W., SUITE 800, WASHINGTON, DC, 20037, US

(73) Assignee: Sumitomo Chemical Company, Limited, Chuo-ku, Tokyo (JP)

(21) Appl. No.: 12/279,850

(22) PCT Filed: Mar. 2, 2007
(86) PCT No.: PCT/JP2007/054610

§ 371 Date: Aug. 19, 2008

(30) Foreign Application Priority Data
Mar. 7, 2006 (JP) 2006-060733
Aug. 22, 2006 (JP) 2006-225058

(51) Int. Cl. G02F 1/13363; G02B 5/30; B29D 11/00

(52) U.S. Cl. 349/117; 359/500; 264/1.34; 427/163.1

(57) ABSTRACT

There is provided a composite retardation plate (10) comprising a first retardation plate (11)/a primer layer (12)/a second retardation plate (14)/a pressure-sensitive adhesive layer (19) which are laminated in this order, in which the second retardation plate (14) is obtained by evaporating an organic solvent from a coating liquid containing an organic modified clay complex and a binder resin in an organic solvent. The composite retardation plate (10) of the present invention can effectively suppress light leakage attributed to the cracking of the second retardation plate (14), liable to occur because of an external physical force, when laminated on a liquid crystal cell, because the first retardation plate (11) and the second retardation plate (14) are laminated on each other through the primer layer (12). Thus, it becomes possible to provide a sufficient display condition.

### TECHNICAL FIELD

The present invention relates to a composite retardation plate to be laminated on a liquid crystal cell, and production thereof, and a composite optical member and a liquid crystal display, each comprising such a composite retardation plate. The present invention also relates to a technique for preventing cracking of a coating retardation plate of a composite retardation plate.

### PRIOR ART

In these years, liquid crystal displays as information-displaying devices such as mobile phones, personal digital assistants, monitors for computers and televisions have rapidly come into wide use, because of many advantages of the LCDs, for example, low electric power consumption, low voltage operation, lightweight and slimness. With the progress of the LCD technologies, liquid crystal displays of various modes have been proposed. Under such circumstances, the problems of the liquid crystal displays in response speed, contrast, narrow viewing angle, etc. are now being overcome.

However, it is pointed out that the viewing angles of LCDs are still left to be narrower than those of cathode ray tubes (CRTs). Under such circumstances, various trials have been made to widen the viewing angles of LCDs.

One of such LCDs is a vertical alignment (or VA) mode LCD in which linear liquid crystal molecules having positive or negative dielectric constant anisotropy are aligned vertically to a substrate. In such a vertical alignment mode, the liquid crystal molecules are aligned vertically to a substrate while they are not driven, and therefore, light passes through a liquid crystal layer without any change in polarization. When linearly polarizing plates are disposed on the upper and lower sides of such a liquid crystal panel so that their polarizing axes can be orthogonal to each other, the liquid crystal panel is seen to be substantially perfect black when viewed in front, and thus, a high contrast ratio can be obtained.

However, the VA mode liquid crystal display of this type in which only the polarizing plates are disposed on the liquid crystal cell suffers from light leakage which leads to a remarkable decrease in contrast ratio. This is because, when the liquid crystal display is viewed from an oblique direction, the axial angles of the disposed polarizing plates are deviated from 90° and the linear liquid crystal molecules in the cell exhibit birefringence.

To eliminate such light leakage, it is necessary to dispose an optical compensation film between the liquid crystal cell and each of the linearly polarizing plates. Therefore, conventionally, each one biaxial retardation plate is disposed between a liquid crystal cell and each of upper and lower polarizing plates; or one positively uniaxial retardation plate and one perfectly biaxial retardation plate are disposed on the upper and lower sides of a liquid crystal cell, respectively, or both the retardation plates are disposed on one side of the liquid crystal cell.

For example, JP-A-2001-109009 discloses a VA mode liquid crystal display in which an a-plate (i.e., a positively uniaxial retardation plate) and a c-plate (i.e., a perfectly biaxial retardation plate) are disposed between an upper polarizing plate and a liquid crystal cell and between a lower polarizing plate and the liquid crystal cell, respectively.

The positively uniaxial retardation plate is a film in which the ratio of its in-plane phase difference R0 to its phase difference Rth in its thickness direction (i.e., R0/Rth) is substantially 2. The perfectly biaxial retardation plate is a film in which the in-plane phase difference R0 is substantially zero (0). In this regard, the in-plane phase difference R0 and the phase difference Rth in the thickness direction are defined by the following equations (I) and (II), respectively:

R0=(nx−ny)×d (I), and

Rth=[(nx+ny)/2−nz]×d (II),

wherein nx represents a refractive index of the film in the direction of an in-plane retarding axis; ny represents a refractive index of the film in the direction of an in-plane advancing axis (i.e., a direction orthogonal to the in-plane retarding axis); nz represents a refractive index in the thickness direction; and d represents a thickness of the film.

The positively uniaxial film has a relationship of nz≈ny, so that the ratio R0/Rth is substantially 2 (R0/Rth≈2). Despite a positively uniaxial film, the ratio R0/Rth may vary within a range of about 1.8 to about 2.2, depending on the change of orienting conditions. Since the perfectly biaxial film has a relationship of nx≈ny, its in-plane phase difference is substantially zero (R0≈0). The perfectly biaxial film is different (or smaller) only in the refractive index in the thickness direction, and thus is negatively uniaxial. Therefore, this film is a film having an optical axis in a normal line direction, and thus it is sometimes called a c-plate as described above.

As an optical compensation film to be used for the above-described purpose, JP-A-2005-338215 discloses a composite retardation plate which is obtained by laminating a second retardation plate consisting of a coating layer with refractive index anisotropy, on a first retardation plate consisting of a transparent resin film oriented in-plane, through a pressure-sensitive adhesive layer. JP-A-2006-10912 discloses the formation of a retardation plate from a coating liquid containing an organic modified clay complex and an urethane resin based on an aliphatic diisocyanate, and a composite polarizing plate obtained by laminating a polarizing plate on the above retardation plate through a pressure-sensitive adhesive layer. However, the structures disclosed in JP-A-2005-338215 and JP-A-2006-10912 have the following disadvantage: since the coating retardation plate is sandwiched between the two pressure-sensitive adhesive layers, stresses concentrate on the coating retardation plate, when an external physical force is applied to the composite retardation plate or the composite polarizing plate, resulting in that the coating retardation plate cracks, which is likely to lead to light leakage.

### SUMMARY OF THE INVENTION

The present inventors have found the following fact in the course of their trials to fabricate a composite retardation plate obtained by laminating a first retardation plate which is in-plane oriented and a second retardation plate made of a coating layer showing refractive index anisotropy on each other: that is, light leakage due to the cracking of the second retardation plate, liable to occur because of an external physical force, can be suppressed by using a primer layer instead of the pressure-sensitive adhesive layer which hitherto has been disposed between the first and second retardation plates. The present invention is accomplished based on this finding.

Therefore, an object of the present invention is to provide a composite retardation plate more capable of suppressing light leakage when laminated on a liquid crystal cell, than any of the conventional composite retardation plates, and to provide a process for producing the same.

Another object of the present invention is to provide a composite optical member which is obtained by laminating an optical layer having other optical function, such as a polarizing plate, on this composite retardation plate and which can suppress light leakage when laminated on a liquid crystal cell.

A further object of the present invention is to provide a liquid crystal display capable of remarkably suppressing light leakage, by using this composite optical member.

Accordingly, the present invention provides a composite retardation plate comprising a first retardation plate, a primer layer, a second retardation plate and a pressure-sensitive adhesive layer which are laminated in this order, wherein the second retardation plate is obtained by evaporating an organic solvent from a coating liquid containing an organic modified clay complex and a binder resin in an organic solvent.

This composite retardation plate can be produced by any one of the following processes.

(1) A process comprising

a primer layer-forming step in which a primer layer is formed on one surface of a first retardation plate;

a coating layer-forming step in which a second retardation plate is formed by applying a coating liquid which contains an organic modified clay complex and a binder resin in an organic solvent, to a transfer substrate to form a coating layer, and evaporating the solvent from the coating layer;

a laminating step in which the primer layer obtained in the primer layer-forming step, and the second retardation plate obtained in the coating layer-forming step are laminated on each other;

a transfer substrate-peeling step in which the transfer substrate is peeled from the second retardation plate; and

a pressure-sensitive adhesive layer-forming step in which a pressure-sensitive adhesive layer is formed on the surface of the second retardation plate,

wherein, at least, the primer layer-forming step and the coating layer-forming step are conducted prior to other steps, and

wherein the respective steps are conducted so as to obtain a layer structure consisting of the first retardation plate/the primer layer/the second retardation plate/the pressure-sensitive adhesive layer in this order.

(2) A process comprising

a primer layer-forming step in which a primer layer is formed on one surface of a first retardation plate;

a coating layer-forming step in which a coating liquid containing an organic modified clay complex and a binder resin in an organic solvent is applied to the surface of the primer layer to form a coating layer, and then the solvent is removed from the coating layer to form a second retardation plate; and

a pressure-sensitive adhesive layer-forming step in which a pressure-sensitive adhesive layer is formed on the surface of the second retardation plate,

wherein the above-described steps are conducted in this order to obtain a layer structure consisting of the first retardation plate/the primer layer/the second retardation plate/the pressure-sensitive adhesive layer in this order.

In the process (1), the laminating step, the transfer substrate-peeling step and the pressure-sensitive adhesive layer-forming step may be conducted in this order after the primer layer-forming step and the coating layer-forming step; or alternatively, the pressure-sensitive adhesive layer-forming step, the transfer substrate-peeling step and the laminating step may be conducted in this order after the primer layer-forming step and the coating layer-forming step.

Furthermore, the present invention provides a composite optical member obtained by laminating an optical layer having other optical function, such as a polarizing plate or the like, on the above-described composite retardation plate.

In addition, the present invention provides a liquid crystal display obtained by disposing the above-described composite optical member on at least one surface of a liquid crystal cell.

### BRIEF DESCRIPTION OF THE DRAWINGS

FIG. 1 shows a schematic sectional view of a composite retardation plate, illustrating the structure thereof.

FIG. 2 shows schematic sectional views for illustrating a first embodiment of fabrication of a composite retardation plate (a first transfer method) so as to describe the respective steps.

FIG. 3 shows a schematic diagram for illustrating a step of forming a primer layer on one surface of a first retardation plate (the first step) in the first transfer method.

FIG. 4 shows a schematic diagram for illustrating a step of forming a second retardation plate on one surface of a transfer substrate, and laminating the primer layer of the first retardation plate (the second step) in the first transfer method.

FIG. 5 shows a schematic diagram for illustrating a step of peeling the transfer substrate after the lamination of the primer layer and the second retardation plate, and forming a pressure-sensitive adhesive layer (the third step) in the first transfer method.

FIG. 6 shows schematic sectional views for illustrating a second embodiment of fabrication of a composite retardation plate (a second transfer method) so as to describe the respective steps.

FIG. 7 shows a schematic diagram for illustrating a step of forming a second retardation plate on one surface of a transfer substrate, and forming a pressure-sensitive adhesive layer on the second retardation plate (the first step) in the second transfer method.

FIG. 8 shows a schematic diagram for illustrating a step of forming a primer layer on one surface of a first retardation plate, and laminating the second retardation plate on the primer layer, while peeling the transfer substrate (the second step) in the second transfer method.

FIG. 9 shows a schematic diagram for illustrating a step of drying the lamination (the third step) after laminating the second retardation plate on the primer layer in the second transfer method.

FIG. 10 shows schematic sectional views for illustrating a third embodiment of fabrication of a composite retardation plate (a coating method) so as to describe the respective steps.

FIG. 11 shows a schematic diagram for illustrating an example of constantly carrying out the process from the formation of a primer layer on a first retardation plate up to the formation of a pressure-sensitive adhesive layer in the coating method.

FIG. 12 shows a schematic diagram for illustrating a step of forming a primer layer on the surface of a first retardation plate (the first step) in the coating method.

FIG. 13 shows a schematic diagram for illustrating a step of forming a second retardation plate on the primer layer formed on the surface of the first retardation plate, and further forming a pressure-sensitive adhesive layer thereon (the second step) in the coating method.

FIG. 14 shows a schematic sectional view of a composite optical member, illustrating the structure thereof.

### DESCRIPTION OF REFERENCE NUMERALS

10 . . . composite retardation plate
11 . . . first retardation plate
12 . . . primer layer
13 . . . first retardation plate with a primer layer
14 . . . second retardation plate
15 . . . transfer substrate
16 . . . second retardation plate with a transfer substrate attached thereto
17 . . . half-finished product comprising a lamination of first retardation plate/primer layer/second retardation plate/transfer substrate
18 . . . half-finished product comprising a lamination of first retardation plate/primer layer/second retardation plate
19 . . . pressure-sensitive adhesive layer
20 . . . film with a pressure-sensitive adhesive
21 . . . half-finished product comprising a lamination of transfer substrate/second retardation plate/pressure sensitive adhesive layer
22 . . . half-finished product comprising a lamination of second retardation plate/pressure sensitive adhesive layer
23 . . . half-finished product comprising a lamination of first retardation plate/primer layer/second retardation plate
30 . . . first retardation plate-feeding roll
31 . . . primer layer-applying machine
32 . . . primer layer-drying zone
35 . . . first half-finished product roll
40 . . . transfer substrate-feeding roll
41 . . . coating layer-applying machine
42 . . . coating layer-drying zone
45 . . . second half-finished product roll
46 . . . second half-finished product-drying zone
47 . . . transfer substrate-peeling roll
48 . . . transfer substrate-winding roll
49 . . . roll for feeding a film with a pressure-sensitive adhesive
50 . . . third half-finished product roll
55 . . . fourth half-finished product roll
56 . . . product-drying zone
60 . . . product roll
70 . . . composite optical member
71 . . . optical layer exhibiting other optical function
72 . . . pressure-sensitive adhesive layer

### BEST EMBODIMENTS FOR CARRYING OUT THE INVENTION

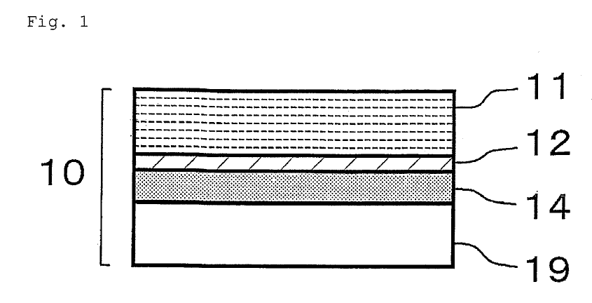

Hereinafter, the embodiments of the present invention will be described in detail with reference to the accompanying drawings. As shown in FIG. 1, a composite retardation plate 10 is fabricated by laminating a first retardation plate 11, a primer layer 12, a second retardation plate 14 and a pressure-sensitive adhesive layer 19 in this order.

Used as the first retardation plate 11 is a film which is oriented in its plane and which has excellent transparency and uniformity, preferably an oriented transparent film formed of a thermoplastic resin, from the viewpoint of easiness to form a film having an orientation property. Examples of the thermoplastic resin include polycarbonates, polyarylates, polysulfones, polyethersulfones, cellulose resins, polyolefin resins comprising, as main monomers, olefins such as propylene and ethylene, and cyclic polyolefin resins comprising, as main monomers, cyclic olefins such as norbornene. It is also possible to use, as the first retardation plate 11, a transparent resin plate of a cellulose resin on which a coating layer of a liquid crystalline material is formed so as to cause a phase difference in the resin plate.

The in-plane phase difference of the first retardation plate may be appropriately selected within a range of about 30 to about 300 nm in accordance with an end use of a composite retardation plate. When a composite retardation plate is used in, for example, a relatively small and compact liquid crystal display for a mobile phone or a personal digital assistant, it is advantageous to use a quarter wavelength plate as the first retardation plate.

Advantageously, the primer layer 12 is formed of a transparent resin by coating. While the term “primer” generally means undercoating, the primer layer 12 referred to in the present invention functions as an undercoating layer for a second retardation plate formed by coating. The formation of the primer layer 12 is effective to prevent an influence of an organic solvent in a coating liquid on the first retardation plate, even when the coating liquid for the second retardation plate 14 is directly applied to the primer layer. The primer layer 12 is formed of a resin which does not show such high elasticity as a pressure-sensitive adhesive. While the type of the resin is not limited, a resin excellent in coatability, particularly a resin capable of imparting excellent transparency and adhesion to a formed layer, is preferably used.

The resin constituting the primer layer 12 may be dissolved in a solvent or may be diluted with a solvent so as to adjust the thickness of the primer layer, before use. Depending on the solubility of the resin, a conventional organic solvent may be used. Examples of the conventional organic solvent include aromatic hydrocarbons (e.g., benzene, toluene, xylene, etc.), ketones (e.g., acetone, methyl ethyl ketone, methyl isobutyl ketone, etc.), esters (e.g., ethyl acetate, isobutyl acetate, etc.), chlorinated hydrocarbons (e.g., chlorinated methylene, trichloroethylene, chloroform, etc.), and alcohols (e.g., ethanol, 1-propanol, 2-propanol, 1-butanol, etc.). However, the primer layer 12 formed of a solution containing an organic solvent is likely to influence the optical characteristics of the first retardation plate 11. Therefore, it is preferable to form the primer layer 12 of a coating liquid containing water as the solvent.

Epoxy resins are given as preferable examples of the resin constituting the primer layer 12, and either one-pack curable type epoxy resins or two-pack curable type epoxy resins may be used. Particularly preferable are water-soluble epoxy resins. An example of the water-soluble epoxy resin is a polyamide epoxy resin which is obtained by a reaction between epichlorohydrin and a polyamide-polyamine obtained by reacting polyalkylene-polyamine such as diethylenetriamine or triethylenetetramine with dicarboxylic acid such as adipic acid. As commercially available polyamide epoxy resins, there are exemplified “SUMIREZ RESIN 650(30)” and “SUMIREZ RESIN 675” (trade names) manufactured by Sumika Chemtex Co., Ltd.

When a water-soluble epoxy resin is used as the resin constituting the primer layer 12, it is preferable to mix such a resin with other water-soluble resin such as a polyvinyl alcohol resin so as to improve the coating property thereof. The polyvinyl alcohol resin may be a partially saponified polyvinyl alcohol or a fully saponified polyvinyl alcohol, or a modified polyvinyl alcohol resin such as a carboxyl group-modified polyvinyl alcohol, an acetoacetyl group-modified polyvinyl alcohol, a methylol group-modified polyvinyl alcohol, an amino group-modified polyvinyl alcohol or the like. Suitable commercially available polyvinyl alcohol resins are “KL-318” and “KL-506” (trade names) which are carboxyl group-modified polyvinyl alcohols, manufactured by KURARAY CO., LTD. The details of these polyvinyl alcohols manufactured by KURARAY CO., LTD. are described as “KURARAY POVAL, special brand” in the poval resin-specialized sight <URL:http://www.poval.jp/japan/poval/s_grades/sg_k.html>(access date: Mar. 3, 2006).

When the primer layer 12 is formed of a coating liquid containing a water-soluble epoxy resin, the concentration of the epoxy resin is preferably about 0.2 to about 5.5 parts by weight per 100 parts by weight of water. The concentration of the epoxy resin per 100 parts by weight of water may be selected from a relatively lower range within the above-specified range, for example, about 0.2 to about 1.5 parts by weight, or from a relatively higher range within the above-specified range, for example, about 0.5 to about 5.5 parts by weight. This selection of the concentration is effective to further improve the function of the primer layer. When this coating liquid is mixed with a polyvinyl alcohol resin, the amount of the resin is preferably from about 1 to about 25 parts by weight per 100 parts by weight of water. The amount of the polyvinyl alcohol resin per 100 parts by weight of water may be selected from a relatively lower rage within the above-specified range, for example, about 1 to about 6 parts by weight, or may be selected from a relatively higher range within the above-specified range, for example, about 5 to about 25 parts by weight. This selection of the amount is also effective. The thickness of the primer layer 12 is preferably from about 0.1 to about 10 μm, more preferably from about 0.5 to about 10 μm.

The coating method to be employed for the formation of the primer layer is not particularly limited, and any of the known coating methods such as the direct gravure method, the reverse gravure method, the die coating method, the comma coating method, the bar coating method or the like may be employed.

The second retardation plate 14 is a layer obtained by evaporating an organic solvent from a coating liquid which contains an organic modified clay complex and a binder resin in an organic solvent.

The organic modified clay complex herein used is a complex of an organic substance and a clay mineral. For example, such a complex is obtained by compounding a clay mineral having a layered structure with an organic compound, and is dispersible in an organic solvent. Examples of the clay mineral having a layered structure include the clay minerals belonging to the smectite group and swelling mica, which can be compounded with organic compounds because of their cation-exchangeability.

Above all, the clay minerals of the smectite group are preferable, because they also have superior transparency. Examples of the clay minerals of the smectite group include hectorite, montmorillonite, bentonite, etc. Among those, chemically synthesized clay minerals are preferable, since they contain less impurities and have superior transparency. Especially preferable is synthesized hectorite controlled smaller in particle size, because the use thereof is effective to suppress scattering of visible rays.

As the organic compound to be compounded with the clay mineral, a compound reactive with an oxygen atom or a hydroxyl group of the clay mineral, or an ionic compound exchangeable with an exchangeable cation is used. There is no limit in selection of the organic compound, in so far as the use of the same compound allows the organic modified clay complex to be swollen or dispersed in an organic solvent. Specific examples of such an organic compound include nitrogen-containing compounds, etc. Examples of the nitrogen-containing compound include primary, secondary or tertiary amines, quaternary ammonium compounds, etc. Among those, the quaternary ammonium compounds are preferable, because of their facility to be exchanged with cations.

In this regard, two or more kinds of organic modified clay complexes may be used in combination. Suitable commercially available organic modified clay complexes are complexes of quaternary ammonium compounds and synthesized hectorites under the trade names of “LUCENTITE STN” and “LUCENTITE SPN” manufactured by CO—OP CHEMICAL CO., LTD.

The organic modified clay complex dispersible in an organic solvent is used in combination with a binder resin, from the viewpoints of facility of coating to the primer layer 12 or a transfer substrate described later, exhibition of optical characteristics and dynamical characteristics. As the binder resin to be used in combination with the organic modified clay complex, there are preferably used binder resins soluble in organic solvents such as toluene, xylene, acetone and ethyl acetate, especially, binder resins having a lower glass transition temperature than room temperature (about 20° C. or lower) It is preferable to use a hydrophobic binder resin in order to obtain sufficient resistance to humidity and heat and handling ease, which are required for the composite retardation plate to be applied to a liquid crystal display. Examples of such a preferable binder resin include polyvinylacetal resins such as polyvinylbutyral and polyvinylformal, cellulose resins such as cellulose acetate butyrate, acrylic resins such as butyl acrylate, urethane resins, methacrylic resins, epoxy resins and polyester resins, etc.

Suitable commercially available binder resins are an aldehyde modified resin of polyvinyl alcohol under the trade name of “Denka Butyral #3000-K” manufactured by DENKI KAGAKU KOGYO KABUSHIKI KAISHA, an acrylic resin under the trade name of “ALON S1601” manufactured by TOAGOSEI CO., LTD., an isophorone diisocyanate-based urethane resin under the trade name of “SBU Lacquer 0866” manufactured by Sumika Bayer Urethane Co., Ltd., etc.

The weight ratio of the organic modified clay complex dispersible in an organic solvent, to the binder resin is from 0.5:1 to 10:1, especially from 1:1 to 2:1. This range of the weight ratio is preferable to improve the dynamic properties such as prevention of cracking of the layer comprising the organic modified clay complex and the binder resin.

The organic modified clay complex and the binder resin are contained in an organic solvent to form a coating liquid, which is then applied to the primer layer 12 or the transfer substrate. Generally, the binder resin is dissolved in the organic solvent, and the organic modified clay complex is dispersed in the organic solvent. The solid concentration of this liquid dispersion is not limited, in so far as the liquid dispersion does not form gel or turn white, accompanied by no problem in practical use after the preparation thereof. However, the organic modified clay complex and the binder resin are usually used so that the total solid concentration of them can be about 3 to about 15% by weight. An optimal solid concentration varies depending on the kinds of the organic modified clay complex and the binder resin, and on their composition ratio, and therefore, the optimal solid concentration is selected in accordance with each of their compositions. Additives such as a viscosity-adjusting agent for improving the coating ability for film-formation, a crosslinking agent for improving the hydrophobicity and/or durability, etc. may be added to the liquid dispersion.

The coating method employed for formation of the second retardation plate 14 is not limited: that is, any of the known coating methods such as the direct gravure method, the reverse gravure method, the die coating method, the comma coating method, the bar coating method or the like may be employed.

The refractive index anisotropy of the second retardation plate in its thickness direction is represented by the phase difference Rth in the thickness direction, defined by the above-described equation (II). This value is calculated from a phase difference value R40 measured when the in-plane lag axis as a tilt axis is inclined to an angle of 40°, and from an in-plane phase difference value R0. That is, the phase difference value Rth in the thickness direction, determined by the equation (II), can be calculated as follows: the in-plane phase difference value R0, the phase difference value R40 found when the lag axis as the tilt axis is inclined to an angle of 40°, the thickness d of the film and an average refractive index n0 of the film are used to find the values of nx, ny and nz by the following numerical equations (III) to (V), and these found values are substituted in the above-described equation (II):

R0=(nx−ny)×d (III),

R40=(nx−ny′)×d/cos(φ) (IV), and

(nx+ny+nz)/3=n0 (V),

wherein φ and ny′ are calculated by the following equations:

φ=sin⁻¹[sin(40°)/n0], and

ny′=ny×nz/[ny2×sin 2(φ)+nz2×cos 2(φ)]^{1/2}.

Preferably, the phase difference Rth of the second retardation plate 14 in its thickness direction is appropriately selected within a range of about 40 to about 300 nm, in accordance with an end use thereof and particularly the characteristics of a liquid crystal cell. The phase difference Rth in the thickness direction is advantageously 50 nm or more, and is advantageously 200 nm or less.

The pressure sensitive adhesive layer 19 comprises, as a base polymer, an acrylic polymer, a silicone-based polymer, a polyester, a polyurethane, a polyether or the like. Above all, it is preferable to selectively use a product such as an acrylic pressure-sensitive adhesive, which is superior in optical transparency and is capable of retaining suitable wettability and a cohesive force, and which is superior in adhesion to a substrate, having weather resistance and heat resistance, and which is free from any problem relative to peeling such as floating and peeling under heating or humidifying conditions. For an acrylic pressure sensitive adhesive, an acrylic copolymer prepared by polymerizing an alkyl ester of an acrylic acid which has an alkyl group having 20 or less carbon atoms, such as a methyl or ethyl group or a butyl group, with a functional group-containing acrylic monomer comprising a (meth)acrylic acid or a hydroxyethyl (meth)acrylate to have a weight-average molecular weight of 100,000 or more and a glass transition temperature of preferably 25° C. or lower, more preferably 0° C. or lower is useful as the base polymer.

Next, the fabrication of the composite retardation plate according to the present invention will be described. As described above, the composite retardation plate according to the present invention can be fabricated by any of the following methods:

(1) the method comprising

a primer layer-forming step where a primer layer is formed on a surface of a first retardation plate;

a coating layer-forming step where a coating liquid containing an organic modified clay complex and a binder resin in an organic solvent is applied to a transfer substrate, followed by removal of the solvent from the resulting coating layer, to thereby form a second retardation plate;

a laminating step where the primer layer obtained in the primer layer-forming step and the second retardation plate obtained in the coating layer-forming step are laminated on each other;

a transfer substrate-peeling step where the transfer substrate is peeled from the second retardation plate; and

a pressure-sensitive adhesive layer-forming step where a pressure-sensitive adhesive layer is formed on the surface of the second retardation plate,

wherein, at least, the primer layer-forming step and the coating layer-forming step are conducted prior to other steps; and
wherein the above-described respective steps are conducted so as to obtain a layer structure of the first retardation plate/the primer layer/the second retardation plate/the pressure-sensitive adhesive layer: and
(2) the method comprising

a primer layer-forming step where a primer layer is formed on a surface of a first retardation plate;

a coating layer-forming step where a coating liquid containing an organic modified clay complex and a binder resin in an organic solvent is applied to the surface primer layer, followed by removable of the solvent from the resulting coating layer, to thereby form a second retardation plate; and

a pressure-sensitive adhesive layer-forming step where a pressure-sensitive adhesive layer is formed on the surface of the second retardation plate,

wherein the above-described steps are conducted in this order to obtain a layer structure of the first retardation plate/the primer layer/the second retardation plate/the pressure-sensitive adhesive layer.

As an example of the method (1), the laminating step, the transfer substrate-peeling step and the pressure-sensitive adhesive layer-forming step are conducted in this order, after the primer layer-forming step and the coating layer-forming step; or otherwise, the pressure-sensitive layer-forming step, the transfer substrate-peeling step and the laminating step are conducted in this order, after the primer layer-forming step and the coating layer-forming step.

In the former method (1), the composite retardation plate having the layer structure of the first retardation plate/the primer layer/the second retardation plate/the pressure sensitive adhesive layer is fabricated by the following procedure: the primer layer is formed on the surface of the first retardation plate (the primer layer-forming step); separately, the coating liquid containing the organic modified clay complex and the binder resin in the organic solvent is applied to the transfer substrate, followed by the removal of the solvent from the resulting coating layer to form the second retardation plate (the coating layer-forming step); the primer layer side of the first retardation plate with the primer layer attached thereto is laminated on the exposed surface of the second retardation plate (the laminating step); then, the transfer substrate is peeled from the second retardation plate (the transfer substrate-peeling step); and the pressure-sensitive adhesive layer is formed on the transfer substrate-free surface of the second retardation plate (the pressure-sensitive adhesive layer-forming step). Hereinafter, this method is optionally referred to as “the first embodiment” or “the first transfer method”.

In the latter method (1), the composite retardation plate having the layer structure of the first retardation plate/the primer layer/the second retardation plate/the pressure sensitive adhesive layer is fabricated by the following procedure: the coating liquid containing the organic modified clay complex and the binder resin in the organic solvent is applied to the transfer substrate, followed by the removal of the organic solvent and water from the resulting coating layer to form the second retardation plate (the coating layer-forming step); the pressure-sensitive adhesive layer is formed on the exposed surface of the second retardation plate (the pressure-sensitive adhesive layer-forming step); separately, the primer layer is formed on the surface of the first retardation plate (the primer layer-forming step); then, the transfer substrate is peeled from the second retardation plate (the transfer substrate-peeling step); and the transfer substrate-free surface of the second retardation plate is laminated on the primer layer side of the first retardation plate (the laminating step). Hereinafter, this method is optionally referred to as “the second embodiment” or “the second transfer method”.

In the method (2), the composite retardation plate having the layer structure of the first retardation plate/the primer layer/the second retardation plate/the pressure sensitive adhesive layer is fabricated by the following procedure: the primer layer is formed on the surface of the first retardation plate (the primer layer-forming step); the coating liquid containing the organic modified clay complex and the binder resin in the organic solvent is applied to the primer layer, followed by the removal of the solvent from the resulting coating layer to form the second retardation plate (the coating layer-forming step); and the pressure-sensitive adhesive layer is formed on the surface of the second retardation plate (the pressure-sensitive adhesive layer-forming step). Hereinafter, this method is optionally referred to as “the third embodiment” or “the coating method”.

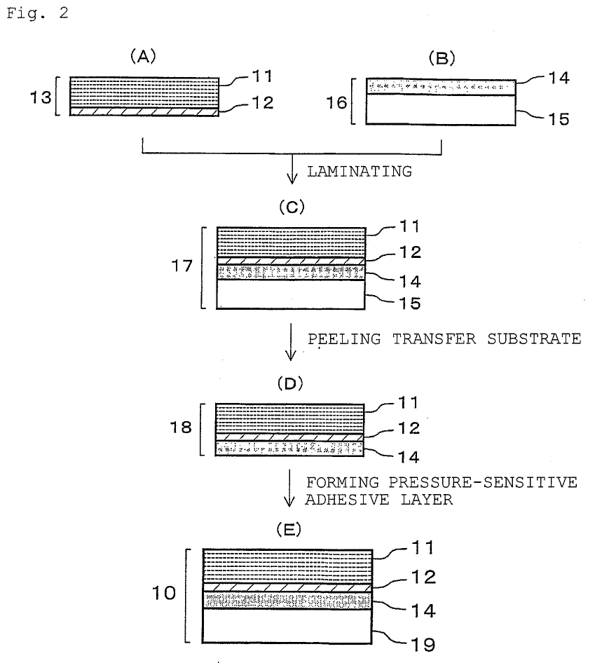

The first embodiment (or the first transfer method) is illustrated in FIG. 2 as the sequential schematic sectional views. First, as shown in FIG. 2(A), the primer layer 12 is formed on the surface of the first retardation plate 11 to prepare the first retardation plate 13 with the primer layer attached thereto. In this step, preferably, the first retardation plate 11 is subjected to a corona discharge treatment on its both surfaces. As shown in FIG. 2(B), separately, the second retardation plate (14) is formed on the surface of the transfer substrate 15 to prepare the second retardation plate 16 with the transfer substrate attached thereto. As shown in FIG. 2(C), the first retardation plate 13 with the primer layer attached thereto and the second retardation plate 16 with the transfer substrate attached thereto are laminated on each other, using the primer layer 12 and the second retardation plate 14 as joint faces. Thus, a semi-fabricated item 17 having a layer structure of the first retardation plate/the primer layer/the second retardation plate/the transfer substrate is obtained. Then, the transfer substrate 15 is peeled and removed from the semi-fabricated item 17 to obtain a semi-fabricated item 18 having a layer structure of the first retardation plate/the primer layer/the second retardation plate as shown in FIG. 2(D). Finally, the pressure-sensitive adhesive layer 19 is formed on the transfer substrate-free surface of the second retardation plate 14 to finish the composite retardation plate 10 having the structure shown in FIG. 2(E).

The steps of fabrication of a roll of a composite retardation plate of this embodiment are illustrated as the schematic sectional views shown in FIGS. 3 to 5. In the first step of this embodiment, the primer layer 12 is formed on the surface of a sheet of the first retardation plate 11, and the resulting sheet is wound up. This is described in more detail with reference to FIG. 3: a coating liquid for primer layer is applied to the surface of the sheet of the first retardation plate 11 rewound from the first retardation sheet-feeding roll 30 by the primer layer-applying machine 31, and the resulting sheet is sequentially allowed to pass through the primer layer-drying zone 32 to be dried. Thus, the sheet of the first retardation plate 13 with the primer layer attached thereto is prepared and is wound onto the first semi-fabricated item roll 35.

When the sheet of the first retardation plate with the primer layer is wound onto the first semi-fabricated item roll 35, the surface of the primer layer 12 is exposed to an air without any cover thereon. Therefore, it is preferable to laminate a protect film which is not adhesive to the primer layer, on the other surface of the first retardation sheet 11 as the opposite side of the surface having the primer layer formed thereon. Again, preferably, the moisture content of the primer layer is kept to about 30 to about 60% by weight during the drying of the primer layer.

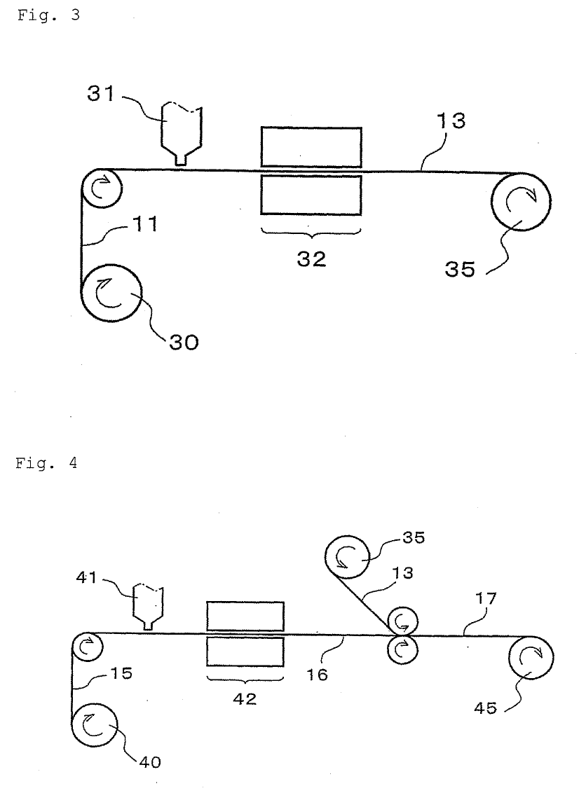

In the sequent second step, the second retardation plate 14 as the coating layer containing the organic modified clay complex is formed on the transfer substrate 15, and the primer layer side of the first retardation plate 13 with the primer layer attached thereto, obtained in the first step, is laminated on the air-exposed surface of the second retardation plate 14. This is described in more detail with reference to FIG. 4: a coating liquid for the coating layer is applied to the surface of the transfer substrate 15 rewound from the transfer substrate-feeding roll 40, by the coating layer-applying machine 41, and the transfer substrate with the coating layer is sequentially allowed to pass through the coating layer-drying zone 42 to be dried. Thus, the second retardation plate 16 with the transfer substrate attached thereto is prepared, and is then laminated on the first retardation plate 13 with the primer layer attached thereto. The first retardation plate 13 with the primer layer attached thereto is once wound onto the first semi-fabricated item roll 35, and is rewound from the same roll 35; and the exposed primer layer 12 of the first retardation plate 13 with the primer layer attached thereto is laminated on the surface of the second retardation plate 14 formed on the transfer substrate 15. Thus, the semi-fabricated item 17 having the layer structure of the first retardation plate/the primer layer/the second retardation plate/the transfer substrate is prepared and is wound onto the second semi-fabricated item roll 45.

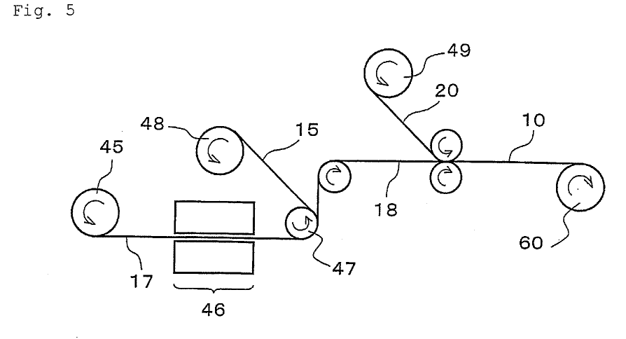

In the third step, the semi-fabricated item 17 having the layer structure of the first retardation plate/the primer layer/the second retardation plate/the transfer substrate is dried, and then, the transfer substrate 15 is peeled from the semi-fabricated item, meanwhile the pressure-sensitive adhesive layer 19 is being formed on the exposed surface of the second retardation plate 14 from which the transfer sheet already had been peeled: that is, the semi-fabricated item is subjected a pressure-sensitive adhesiveness-imparting treatment. This is described in more detail with reference to FIG. 5: the semi-fabricated item 17 having the layer structure of the first retardation plate/the primer layer/the second retardation plate/the transfer substrate once wound onto the semi-fabricated item roll 45 in the second step shown in FIG. 4 is rewound from the same roll 45 and is allowed to pass through the second semi-fabricated item-drying zone 46 to be dried. After that, the transfer substrate 15 is peeled by the transfer substrate-peeling roll 47, and the film 20 with the pressure-sensitive adhesive applied thereto rewound from the feeding roll 49 is fed to the surface of the second retardation plate 14, exposed by the peeling, so that the pressure-sensitive adhesive layer side of the film 20 can be laminated on the surface of the second retardation plate. The resultant composite retardation plate is wound onto the product roll 60. The transfer substrate 15 which has been peeled off is wound onto the transfer substrate-winding roll 48. The composite retardation plate 10 comprising the lamination of the first retardation plate/the primer layer/the second retardation plate/the pressure sensitive adhesive layer in this order can be obtained through these steps.

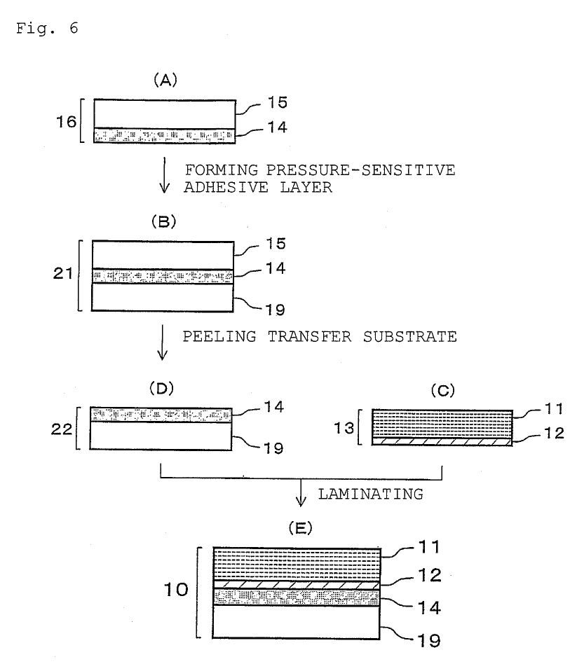

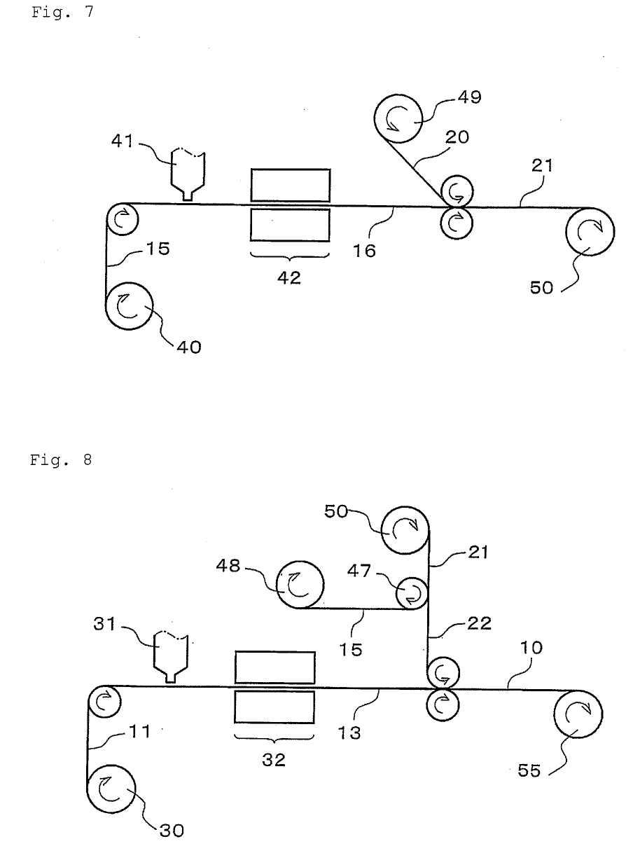

The curves with arrowheads seen in FIGS. 3 to 5 indicate the rotating directions of the rolls, and the curves with arrowheads seen in the following FIGS. 7 to 9 and FIGS. 11 to 13 means the same.

The second embodiment (or the second transfer method) is illustrated as the schematic sectional views shown in FIG. 6. In this embodiment, first, as shown in FIG. 6(A), the second retardation plate 14 as the coating layer containing the organic modified clay complex is formed on the transfer substrate 15 to prepare the second retardation plate 16 with the transfer substrate attached thereto. Then, as shone in FIG. 6(B), the pressure-sensitive adhesive layer 19 is formed on the air-exposed surface of the second retardation plate 14 of the second retardation plate 16 with the transfer substrate attached thereto, to prepare the semi-fabricated item 21 having a layer structure of the transfer substrate/the second retardation plate/the pressure-sensitive adhesive layer. As shown in FIG. 6(C), separately, the primer layer 12 is formed on the surface of the first retardation plate 11 to prepare the first retardation plate 13 with the primer layer attached thereto. In this step, preferably, the first retardation plate 11 is subjected to a corona discharge treatment at its both surfaces. The transfer substrate 15 is peeled and removed from the semi-fabricated item 21 shown in FIG. 6(B) to obtain the semi-fabricated item 22 having a layer structure of the second retardation plate/the pressure-sensitive adhesive layer as shown in FIG. 6(D). Then, the primer layer 12 of the first retardation plate 13 with the primer layer attached thereto is laminated on the side of the second retardation plate 14 of the semi-fabricated item 22, to thereby finish the composite retardation plate 10 shown in FIG. 6(E).

The steps of manufacturing a roll of the composite retardation plate of this embodiment are illustrated as the schematic sectional views shown in FIGS. 7 to 9. In the first step of this embodiment, the second retardation plate 14 as the coating layer containing the organic modified clay complex is formed on the transfer substrate 15; and the pressure-sensitive adhesive layer 19 is formed on the air-exposed surface of the second retardation plate 14. In other words, the second retardation plate 14 is subjected to a pressure-sensitive adhesiveness-imparting treatment. This is described in more detail with reference to FIG. 7: the coating liquid for the coating layer is applied to the surface of the transfer substrate 15 rewound from the transfer substrate-feeding roll 40 by the coating layer-applying machine 41, and is sequentially allowed to pass through the coating layer-drying zone 42 to be dried, and the dried coating layer is laminated on the film 20 with a pressure-sensitive adhesive applied thereon. The pressure-sensitive adhesive layer side of the film 20 with the pressure-sensitive adhesive applied thereon, rewound from the film-feeding roll 49, is laminated on the air-exposed surface of the second retardation plate 16 with the transfer substrate attached thereto, to thereby prepare the semi-fabricated item 21 having a layer structure of the transfer substrate/the second retardation plate/the pressure-sensitive adhesive layer, which is then wound onto the third semi-fabricated item roll 50.

In the sequent second step, the primer layer is formed on the surface of the first retardation plate; and the semi-fabricated item 22 obtained by peeling the transfer substrate 15 from the semi-fabricated item 21 obtained in the first step is laminated on the air-exposed surface of the primer layer. This is described in more detail with reference to FIG. 8: the coating liquid for the primer layer is applied to the surface of the first retardation plate 11 rewound from the first retardation sheet-feeding roll 30 by the primer layer-applying machine 31 and is sequentially allowed to pass through the primer layer-drying zone 32 to be dried. Then, the first retardation plate with the primer layer attached thereto is laminated on the semi-fabricated item 22. The semi-fabricated item 21 once wound onto the third semi-fabricated item roll 50 in the first step is rewound from the same roll 50, and the transfer substrate 15 is peeled by the transfer substrate-peeling roll 47 to prepare the semi-fabricated item 22 having the layer structure of the second retardation plate/the pressure-sensitive adhesive layer. The surface of the second retardation plate 14, exposed by the peeling, is laminated on the surface of the primer layer 12 of the first retardation plate 13 with the primer layer attached thereto, to thereby prepare the laminated retardation plate 10 having a layer structure of the first retardation plate/the primer layer/the second retardation plate/the pressure-sensitive adhesive layer, which is then wound onto the fourth semi-fabricated item roll 55. The peeled transfer substrate 15 is wound onto the transfer substrate-winding roll 48.

Preferably, the primer layer 12 is so dried in the second step that its moisture content can be kept at from about 30 to about 60% by weight.

In the third step, the laminated retardation plate 10 is dried. This is described in more detail with reference to FIG. 9: the laminated retardation plate 10 once wound onto the fourth semi-fabricated item roll 55 in the second step shown in FIG. 8 is rewound from the same roll 55 and is allowed to pass through the product-drying zone 56 to be dried, and the resultant product is wound onto the product roll 60. Through these steps, the composite retardation plate 10 comprising the lamination of the first retardation plate/the primer layer/the second retardation plate/the pressure-sensitive adhesive layer in this order can be obtained.

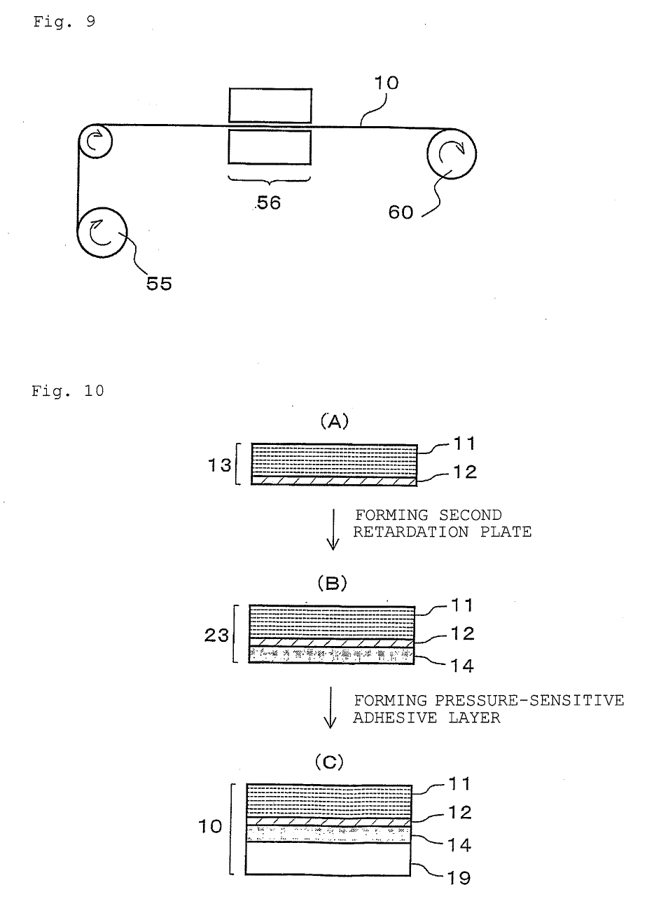

The third embodiment (or the coating method) is illustrated as the schematic sectional views shown in FIG. 10. In this embodiment, first, as shown in FIG. 10(A), the primer layer 12 is formed on the surface of the first retardation plate 11 to prepare the first retardation plate 13 with the primer layer attached thereto. In this step, it is preferable to subject both surfaces of the first retardation plate 11 to a corona discharge treatment. After that, the second retardation plate 14 is formed on the surface of the primer layer 12 to prepare the semi-fabricated item 23 having a layer structure of the first retardation plate/the primer layer/the second retardation plate as shown in FIG. 10(B). The pressure-sensitive adhesive layer 19 is further formed on the surface of the second retardation plate 14 to finish the composite retardation plate 10 as shown in FIG. 10(C).

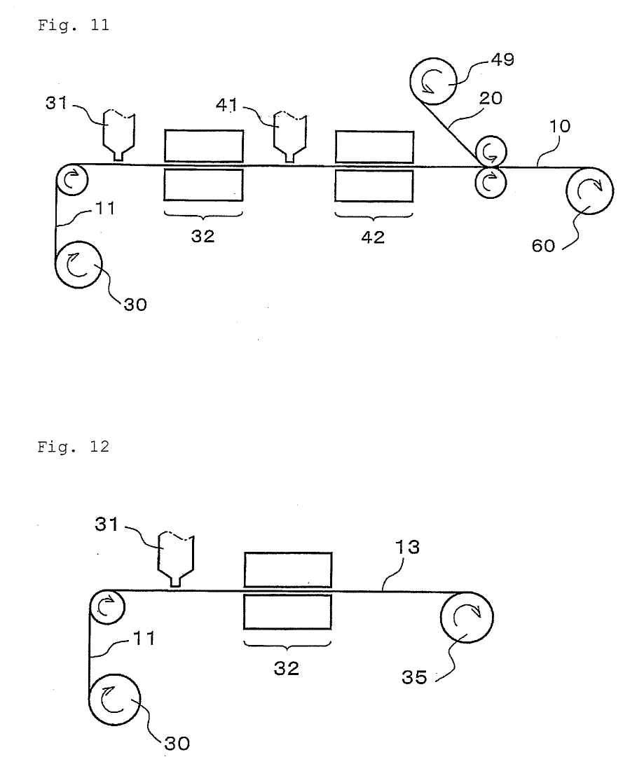

An example of manufacturing of a roll of the composite retardation plate by this embodiment (or the coating method) is illustrated as the schematic sectional views shown in FIG. 11. In this embodiment, the coating liquid for the primer layer is applied to the surface of the first retardation plate 11 rewound from the first retardation plate-feeding roll 30, by the primer layer-applying machine 31. The first retardation plate with the coating layer is sequentially allowed to pass through the primer layer-drying zone 32 to be dried. After that, the first retardation plate with the primer layer is used to form the second retardation plate as the coating layer. Also, in this case, it is preferable to subject both surfaces of the first retardation plate 11 to a corona discharge treatment. Then, the coating liquid for the coating layer is applied to the air-exposed surface of the primer layer 12 by the coating layer-applying machine 41, and is sequentially allowed to pass through the coating layer-drying zone 42 to be dried. After that, the resulting lamination is laminated on the film 20 with a pressure-sensitive adhesive applied thereto. This film 20 with the adhesive rewound from the film-feeding roll 49 is fed to the air-exposed surface of the second retardation plate so that the pressure-sensitive adhesive side of the film can be laminated on the air-exposed surface of the second retardation plate. The resulting lamination is then wound onto the product roll 60. Through these steps, the composite retardation plate 10 comprising the lamination of the first retardation plate/the primer layer/the second retardation plate/the pressure-sensitive adhesive layer in this order can be obtained.

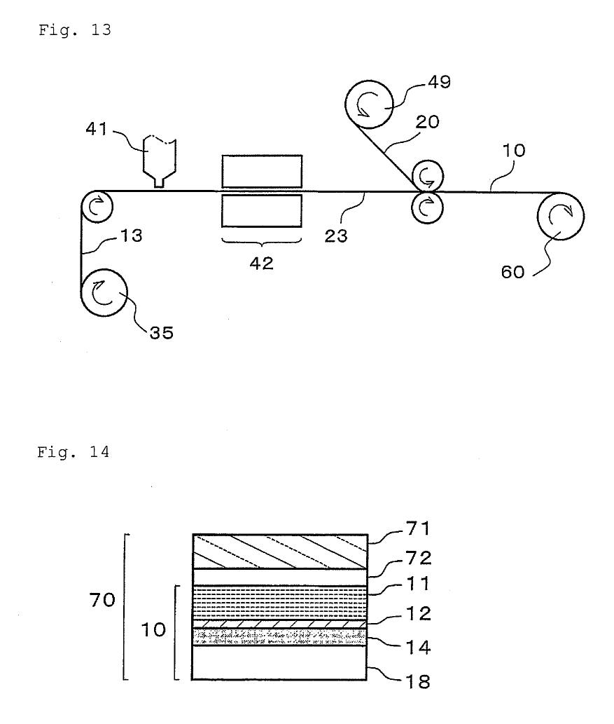

It is also possible to divide the coating method shown in FIG. 11 into two steps. An example of this case is illustrated as schematic sectional views shown in FIGS. 12 and 13. In the first step, as shown in FIG. 12, the coating liquid for the primer layer is applied to the surface of the first retardation plate 11 rewound from the first retardation plate-feeding roll 30, by the primer layer-applying machine 31, and is sequentially allowed to pass through the primer layer-drying zone 32 to be dried. After that, the first retardation plate 13 with the primer layer attached thereto is prepared and is wound onto the first semi-fabricated item roll 35.

In the second step shown in FIG. 13, the first retardation plate 13 with the primer layer attached thereto, once wound onto the first semi-fabricated item roll 35 in the first step shown in FIG. 12, is rewound from the same roll 35. The coating liquid for the coating layer is applied to the surface of the first retardation plate 13, by the coating layer-applying machine 41, and is sequentially allowed to pass through the coating layer-drying zone 42 to be dried. Thus, the semi-fabricated item 23 having a layer structure of the first retardation plate/the primer layer/the second retardation plate is prepared, and is then laminated on the film 20 with the pressure-sensitive adhesive applied thereon. The film 20 with the adhesive rewound from the film-feeding roll 49 is fed to the air-exposed surface of the second retardation plate so that the pressure-sensitive adhesive layer side of the film 20 can be laminated on the air-exposed surface of the second retardation plate. The resulting lamination is then wound onto the product roll 60. Through these steps, the composite retardation plate 10 comprising the lamination of the first retardation plate/the primer layer/the second retardation plate/the pressure-sensitive adhesive layer in this order can be obtained.

In each of FIGS. 5, 7, 11 and 13, the pressure-sensitive adhesive layer is illustrated as the film 20 with the pressure-sensitive adhesive applied thereto, which is laminated at its pressure-sensitive adhesive layer side. Otherwise, a pressure-sensitive adhesive coating liquid may be applied to form the pressure-sensitive adhesive layer. In FIGS. 3 to 5, FIGS. 7 to 9 and FIGS. 11 to 13, the like portions are denoted by the like reference numerals, respectively. It will be understood that particularly FIGS. 3 and 12 illustrate the same situations.

In each of the first embodiment (or the first transfer method) and the second embodiment (or the second transfer method) described above, the transfer substrate 15 used to form the second retardation plate 14 thereon as the coating layer may be a film so treated as to facilitate peeling of a layer formed thereon. Since a resin film of polyethylene-terephthalate or the like which is treated at its surface by applying a release agent such as a silicon resin or a fluororesin is commercially available, such a film as it is may be directly used. Since the second retardation plate 14 is formed as the coating layer on the transfer substrate 15 by coating, the contact angle of water to the surface of the transfer substrate on which the coating layer is formed is preferably from 90 to 130°, more preferably 100° or larger or 120° or smaller. When the contact angel of water to such a surface is smaller than 90°, the peeling of the transfer substrate after the formation of the coating layer is insufficient, which is likely to cause a defect such as variation in phase difference in the second retardation plate 14 after the peeling of the transfer substrate. When the contact angle of water to such a surface is larger than 130°, the coating liquid applied to such a surface tends to cause cissing before drying the same, with the result that in-plane spot-like variations may occur in the phase difference. The contact angle of water herein referred to means a contact angle found when water is used as a liquid, and a larger and larger value of the contact angle (180° as the upper limit) means that the material is harder and harder to be wetted by water.

In any of the above-described embodiments, the chlorine content of the coating liquid, for the coating layer, containing the organic modified clay complex and the binder resin in the organic solvent is preferably 2,000 ppm or less. The organic modified clay complex is more likely to contain a chlorine-containing compound as an impurity, because of its starting materials for use in production thereof. When the organic modified clay compound containing a large amount of such a chlorine-containing compound is used as it is, the chlorine-containing compound is likely to bleed out from the film which is the second retardation plate formed by coating. In such a case, pressure-sensitive adhesiveness significantly lowers with time, when the resultant composite retardation plate is laminated on a liquid crystal cell glass through the pressure-sensitive adhesive layer. To overcome this problem, it is preferable to remove the chlorine compound by washing the organic modified clay complex, so that the content of chlorine in the organic modified clay complex is adjusted to 2,000 ppm or less. By doing so, the pressure-sensitive adhesiveness can be prevented from lowering. The removal of the chlorine complex is enabled by washing the organic modified clay compound with water.

It is more preferable to adjust the water content of the coating liquid for the coating layer to from 0.15 to 0.35% by weight when measured with a Karl Fischer's moisture meter. When the water content exceeds 0.35% by weight, a phase separation occurs in a water-insoluble organic solvent, and the coating liquid tends to be separated into two phases. On the other hand, when the water content is less than 1.5% by weight, the resultant retardation plate formed of such a coating liquid tends to show a higher haze value. While there are various moisture content-measuring methods such as the drying method, the Karl Fischer's method, and the dielectimetry, etc., the Karl Fischer's method simple and capable of measuring a trace quantity is employed in the present invention.

While there is no limit in selection of the method for adjusting the water content of the coating liquid for the coating layer, addition of water to the coating liquid is a simple and preferable method. Merely mixing of an organic solvent, an organic modified clay complex and a binder resin as are used in the present invention, by a conventional method hardly leads to a water content of 0.15% by weight or more. To overcome this problem, it is preferable to adjust the water content to a value within the above-specified range by adding a small amount of water to the coating liquid comprising the mixture of the organic solvent, the organic modified clay complex and the binder resin. Water may be added at any time during the coating liquid-preparing step, and the timing for addition of water is not limited. However, preferably, a predetermined amount of water should be added after the sampling of the coating liquid for measurement of the water content thereof after a given time elapsed in the course of the preparation of the coating liquid, because this method makes it possible to control the water content with higher reproducibility and higher precision. In this regard, the amount of added water is sometimes not equal to the result measured with the Karl Fischer's moisture meter, because of a possible interaction (for example, adsorption) between a part of water and the organic modified clay complex. It is, however, ensured to keep lower the haze value of the resultant coating retardation plate by maintaining the water content measured with the Karl Fischer' moisture meter to from 0.15 to 0.35% by weight.

The composite retardation plate thus obtained is laminated on an optical layer which exhibits other kind of optical function, such as a polarizing plate or the like, to fabricate a composite optical member. FIG. 14 shows an example of the layer structure of the composite optical member as the schematic sectional view thereof. In this example, an optical layer 71 which exhibits other kind of optical function is laminated on the side of the first retardation plate 11 of the composite retardation plate 10 shown in FIG. 1, to fabricate a composite optical member 70. For example, a pressure-sensitive adhesive is used for the lamination of both of them, and this is shown as a pressure-sensitive adhesive layer 72 in FIG. 14. Preferably, the optical layer 71 which exhibits other kind of optical function includes, at least, a polarizing plate, and additionally may include conventional members for use in fabrication of a liquid crystal display, etc., such as a luminance-improving film and so on.

A polarizing plate as other optical layer 71 transmits a linearly polarized light ray which has an oscillating face in one in-plane direction, and absorbs a linearly polarized light ray which has an oscillating face in a direction orthogonal to the above one in-plane direction.

In concrete, there can be used a polarizer which comprises a polyvinyl alcohol film having dichroic pigments adsorbed and aligned thereon and which has protective film(s) laminated on at least one side (i.e., one side or both sides) thereof. Examples of the polarizer include an iodine type polarizer using iodine as a dichroic pigment and a dye type polarizer using a dichroic organic dyestuff, both of which may be used in the present invention. As the protective film, there is used a cellulose resin such as triacetyl cellulose, a cyclic polyolefin resin comprising, as a main monomer, a cyclic olefin such as norbornene or the like. When other optical layer 71 includes a polarizing plate, it is preferable to laminate other optical layer 71 including this polarizing plate, on the side of the first retardation plate 11 of the composite retardation plate 10, as shown in FIG. 14.

When a pressure-sensitive adhesive is used for the lamination of other optical layer 71, the pressure-sensitive adhesive may be the same one as the pressure-sensitive adhesive for use in the pressure-sensitive adhesive layer 19 previously described with reference to FIG. 1.

The composite optical member 70 shown in FIG. 14 is disposed on at least one side of a liquid crystal cell to fabricate a liquid crystal display. Otherwise, such composite optical members may be disposed on both sides of the liquid crystal cell. When the composite optical member is disposed on one side of the liquid crystal cell, another polarizing plate is disposed on the other side of the liquid crystal cell, optionally through a retardation plate. As the liquid crystal cell, a vertical alignment (or VA) mode liquid crystal cell is preferable as described in the part of Prior Art. Furthermore, the composite retardation plate or the composite optical member of the present invention can effectively function relative to other mode liquid crystal cell such as a bend alignment (ECB) mode liquid crystal cell.

Hereinafter, the present invention will be described in more detail by Examples thereof, which should not be construed as limiting the scope of the present invention in any way. In Examples, the units indicating contents or amounts to be used, i.e., part and %, are based on weight, unless otherwise specified. The composition of a coating liquid for primer layer used in Example 1 to 6 and the composition of a coating liquid for second retardation plate used in all of Examples and Comparative Examples are described below.

### [Coating Liquid for Primer Layer Used in Examples 1 to 6](Referred to as Coating Liquid a for Primer Layer)

This coating liquid was prepared by blending “SUMIREZ RESIN 650(30)” (trade name, an aqueous solution having a solid content of 30%) which is a polyamide epoxy resin manufactured by Sumika Chemtex Co., Ltd., as a water-soluble epoxy resin, and “KL-318” (trade name) which is a carboxyl group-modified polyvinyl alcohol manufactured by KURARAY CO., LTD., as a polyvinyl alcohol resin, in the following composition.

Composition of Coating Liquid A for Primer Layer:

| | | |
|---|---|---|
| Water | 100 | parts |
| Polyamide epoxy resin | 1.5 | parts |
| “SUMIREZ RESIN 650(30)” | | |
| Polyvinyl Alcohol “KL-318” | 3 | parts |

This coating liquid was prepared by mixing the polyvinyl alcohol “KL-318” with water which was being heated to 100° C., stirring the mixture and cooling the same to a room temperature, further mixing the mixture with the polyamide epoxy resin “SUMIREZ RESIN 650(30)”, and stirring the mixture to obtain the coating liquid.

### [Coating Liquid for Second Retardation Plate]

As the organic modified clay complex, there was used “LUCENTITE STN” (trade name) manufactured by CO—OP CHEMICAL CO., LTD., which was a complex of a synthesized hectolite and a trioctylammonium ion. As the binder resin, there was used “SBU Lacquer 0866” (trade name) manufactured by Sumika Bayer Urethane Co., Ltd., which is a resin vanish having a solid content of 30%, and which is an isophoronediisocyanate-based polyurethane resin. A coating liquid for second retardation plate was prepared by mixing the components in the following composition:

Composition of Coating Liquid for Second Retardation Plate:

| | |
|---|---|
| Urethane resin vanish “SBU Lacquer 0866” | 16.0 parts |
| Organic modified clay complex | 7.2 parts |
| “LUCENTITE STN” | |
| Toluene | 76.8 parts |
| Water | 0.3 parts |

The organic modified clay complex herein used was available as such prepared on the side of the manufacturer, by washing a synthesized hectolite with an acid before organically modifying the same, organically modifying the washed hectolite, and further washing the modified hectolite with water. The chlorine content of the organic modified clay complex was 1,111 ppm. This coating liquid was prepared by mixing the components in the above-described composition, stirring the mixture and filtering the same with a filter of a pore size of 1 μm. The water content of the coating liquid measured with a Karl Fischer's moisture meter was 0.25%. The weight ratio of the organic modified clay complex to the binder resin, as the solid contents in this coating liquid, was 6/4.

### Example 1

### (a) Fabrication of Composite Retardation Plate

In this Example, a composite retardation plate was fabricated by the above-described first transfer method. First, the above-described coating liquid A for primer layer was applied to a retardation plate which was an uniaxially oriented film of a norbornene resin [“CSES430120Z-F-KY” manufactured by Sumitomo Chemical Company, Limited; in-plane phase difference: 120 nm; i.e., a first retardation plate] and was dried at 80° C. for one minute to form a primer layer having a moisture content of about 35%. Separately, a polyethylene terephthalate film with a thickness of 38 μm, subjected to a mold-release treatment (contact angle of water to the treated surface: 100°) was used as a transfer substrate; and the above-described coating liquid for second retardation plate was applied to the treated surface of the transfer substrate and was dried at 90° C. for 3 minutes to form a second retardation plate consisting of the coating layer. The first retardation plate having the primer layer formed thereon and the second retardation plate formed on the transfer substrate were laminated on each other, using, as joint faces, the primer layer and the second retardation plate. The resulting lamination was dried in an oven for about 10 minutes so that the moisture content of the primer layer could be less than 0.5%. After that, the transfer substrate was peeled from the second retardation plate, and an acrylic pressure-sensitive adhesive (“P-3132 manufactured by LINTEC CO., LTD.) was applied to the surface of the second retardation plate from which the transfer substrate already had been peeled, to obtain a composite retardation plate comprising the lamination of the first retardation plate/the primer layer/the second retardation plate/the pressure-sensitive adhesive layer in this order. The thickness of the primer layer in this Example was from about 0.2 to about 0.3 μm.

### (a1) Evaluation 1 of Adhesion Force between Primer Layer and Second Retardation Plate: Peeling Test

This composite retardation plate was cut into chips of 25 mm in width×about 250 mm in length; and the chip was applied at its pressure-sensitive adhesive layer side to a soda glass plate, and was then subjected to a pressure treatment in an autoclave at 50° C. under a pressure of 5 kgf/cm² for 20 minutes. Then, the adhesion force of the resulting chip of the composite retardation plate was measured with “Autograph AG-1”, an instrument manufactured by SHIMADZU CORPORATION, under conditions of peeling at an angle of 180° and a pulling rate of 300 mm/min. so as to evaluate the adhesion force between the primer layer and the second retardation plate. As a result, the pressure-sensitive adhesive layer was broken at 9.4 N during the test. Therefore, the adhesion force between the primer layer and the second retardation plate was estimated to be at least 9.4 N. After that, the peeling was continued, and it was found that the pressure-sensitive adhesive layer and the second retardation plate were left to remain on the surface of the soda glass plate, occupying 57% of the laminated area of the glass plate.

### (a2) Evaluation 2 of Adhesion Force between Primer Layer and Second Retardation Plate: Crosshatch Test

The composite retardation plate obtained in the step (a) was laminated at its pressure-sensitive adhesive layer side to a soda glass plate, and was cross-cut from the side of the first retardation plate in accordance with JIS D 0202-1988 so as to conduct a crosshatch test (described as “cross-cut adhesion test” in JIS). The adhesion force was evaluated based on the number of peeled cross-cut chips per 100 cross-cut chips. As a result, the number of the peeled cross-cut chips was 100/100.

### (b) Fabrication of Composite Optical Member

A polyvinyl alcohol/iodine-based polarizing plate [“SRW062AP6-HC2” manufactured by Sumitomo Chemical Company Limited] having a pressure-sensitive adhesive applied thereto was laminated at its pressure-sensitive adhesive layer side to the surface of the first retardation plate side of the composite retardation plate obtained in the step (a), to fabricate a composite optical member comprising the lamination of the polarizing plate/the pressure-sensitive adhesive layer/the first retardation plate/the primer layer/the second retardation plate/the pressure-sensitive adhesive layer in this order.

### (b1) Evaluation of Light Leakage Attributed to Cracking of Second Retardation Plate Due to External Force

This composite optical member was laminated at its outermost pressure-sensitive adhesive layer side to a soda glass plate. After that, a pencil with a hardness of H was pressed down onto the polarizing plate side of the composite optical member, using a pencil hardness tester. A load on the pencil was increased to find and record a load under which light leakage occurred, so as to evaluate light leakage attributed to cracking of the second retardation plate due to an external force. In this test, another new polarizing plate was disposed on the opposite surface of the soda glass plate having the composite optical member laminated on its one surface, so that this polarizing plate could be in a crossnicol state with the polarizing plate of the composite optical member. Then, light leakage from this lamination was checked on a light box. As a result, no light leakage occurred even under a load of 2.0 kg as the limit of loading.

### (b2) Evaluation of Light Leakage Attributed to Cracking of End Portion of Second Retardation Plate Due to Cutting

The composite optical member obtained in the above step (b) was cut into rectangular chips of 41.42 to 56.40 mm in the vertical direction×31.34 to 43.00 mm in the transverse direction, using “SUPER CUTTER NS-1200” manufactured by OGINO SEIKI, so as to check whether or not light leakage occurred at the end portions of the chip. In this test, another new polarizing plate was disposed on the opposite surface of the soda glass plate having the composite optical member laminated on its one surface, so that this polarizing plate could be in a crossnicol state with the polarizing plate of the composite optical member. Then, light leakage from this lamination was checked on a light box. As a result, no light leakage occurred in any of the end portions of the four sides of the chip.

### Example 2

### (a) Fabrication of Composite Retardation plate and Evaluation Thereof

In this Example, a composite retardation plate was fabricated by the second transfer method. First, the above-described coating liquid for second retardation plate was applied to a transfer substrate of a polyethylene terephthalate film which was the same one as that used in Example 1 and was then dried under the same conditions as those in Example 1, to form a second retardation plate consisting of the coating layer. An acrylic pressure-sensitive adhesive [“P-3132” manufactured by LINTEC CO., LTD.] was applied to the surface of the second retardation plate to prepare the second retardation plate having the pressure-sensitive adhesive layer formed thereon. Separately, the above-described coating liquid A for primer layer was applied to a retardation plate “CSES430120Z-F-KY” (as a first retardation plate) which was an uniaxially oriented film of the same norbornene resin as used in Example 1, and was dried under the same conditions as in Example 1, to form a primer layer. The transfer substrate was peeled from the second retardation plate having the pressure-sensitive adhesive layer formed thereon, and the exposed surface of the second retardation plate was laminated on the primer layer of the first retardation plate. The resulting lamination was dried in an oven for about 10 minutes so that the moisture content of the primer layer could be less than 0.5%. Thus, a composite retardation plate comprising the lamination of the first retardation plate/the primer layer/the second retardation plate/the pressure-sensitive adhesive layer in this order was obtained.

A peeling test was conducted on this composite retardation plate in the same manner as in the step (a1) of Example 1. The pressure-sensitive adhesive layer was broken at 9.9 N during the test. Thus, the adhesion force between the primer layer and the second retardation plate was estimated to be at least 9.9 N. After that, the peeling was continued to find that the pressure-sensitive adhesive layer and the second retardation plate were left to remain on the surface of the soda glass plate, occupying 25% of the laminated area of the glass plate.

A crosshatch test was conducted on this composite retardation plate in the same manner as in the step (a2) of Example 1. As a result, the number of the peeled cross-cut chips was 100/100.

### (b) Fabrication of Composite Optical Member and Evaluation Thereof

The same polarizing plate, “SR06AP6-HC2”, having the pressure-sensitive adhesive layer formed thereon as that used in the step (b) of Example 1 was laminated on the surface of the first retardation plate side of the composite retardation plate obtained in the step (a), to fabricate a composite optical member comprising the lamination of the polarizing plate/the pressure-sensitive adhesive layer/the first retardation plate/the primer layer/the second retardation plate/the pressure-sensitive adhesive layer in this order.

This composite optical member was evaluated in light leakage attributed to cracking of the second retardation plate due to an external force, in the same manner as in the step (b1) of Example 1. As a result, no light leakage occurred even under a load of 2.0 kg as the limit of loading.

This composite optical member was also evaluated in light leakage attributed to cracking of the end portions of the second retardation plate due to cutting, in the same manner as in the step (b2) of Example 1. As a result, no light leakage occurred in any of the end portions of the four sides of the chip.

### Example 3

### (a) Fabrication of Composite Retardation Plate and Evaluation Thereof

In this Example, a composite retardation plate was fabricated by the above-described coating method. First, the above-described coating liquid A for primer layer was applied to a retardation plate “CSES4301Z-F-KY” (as a first retardation plate) which was an uniaxially oriented film of the same norbornene resin as used in Example 1, and was dried at 80° C. for about 10 minutes, to form a primer layer having a moisture content of about 0.5%. Next, the above-described coating liquid for second retardation plate was applied to the primer layer, and was then dried at 90° C. for 3 minutes, to form a second retardation plate consisting of the coating layer. An acrylic pressure-sensitive adhesive [“P-3132” manufactured by LINTEC CO., LTD.] was applied to the surface of the second retardation plate to obtain a composite retardation plate comprising the lamination of the first retardation plate/the primer layer/the second retardation plate/the pressure-sensitive adhesive layer in this order.

A crosshatch test was conducted on this composite retardation plate in the same manner as in the step (a2) of Example 1. As a result, the number of the peeled cross-cut chips was 100/100.

### (b) Fabrication of Composite Optical Member and Evaluation Thereof

The same polarizing plate, “SR6AP6-HC2”, having the pressure-sensitive adhesive layer formed thereon, as that used in the step (b) of Example 1 was laminated at its pressure-sensitive adhesive layer side on the surface of the first retardation plate side of the composite retardation plate obtained in the step (a), to fabricate a composite optical member comprising the lamination of the polarizing plate/the pressure-sensitive adhesive layer/the first retardation plate/the primer layer/the second retardation plate/the pressure-sensitive adhesive layer in this order.

This composite optical member was evaluated in light leakage attributed to cracking of the second retardation plate due to an external force, in the same manner as in the step (b1) of Example 1. As a result, no light leakage occurred even under a load of 2.0 kg as the limit of loading.

This composite optical member was also evaluated in light leakage attributed to cracking of the end portions of the second retardation plate due to cutting, in the same manner as in the step (b2) of Example 1. As a result, no light leakage occurred in any of the end portions of the four sides of the chip.

### Comparative Example 1

### (a) Fabrication of Composite Retardation Plate

The above-described coating liquid for second retardation plate was applied to a transfer substrate of a polyethylene terephthalate film which was the same one as that used in Example 1 and was then dried under the same conditions as those in Example 1, to form a second retardation plate consisting of the coating layer. A retardation plate [“CSES430120Z6-F8-KY” manufactured by Sumitomo Chemical Company Limited], which was formed of the same material as that constituting each of the first retardation plates used in Examples 1 to 3 and which had the same in-plane phase difference and had a pressure-sensitive adhesive layer formed on its one side, was laminated at its pressure-sensitive adhesive layer side, to the second retardation plate side of the above lamination. The transfer substrate was peeled from the second retardation plate, and an acrylic pressure-sensitive adhesive [“P-3132” manufactured by LINTEC CO., LTD.] was applied to the surface of the second retardation plate to fabricate a composite retardation plate comprising the lamination of the first retardation plate/the pressure-sensitive adhesive layer/the second retardation plate/the pressure-sensitive adhesive layer in this order.

### (b) Fabrication of Composite Optical Member and Evaluation Thereof

The same polarizing plate, “SRW062A6-HC2”, having the pressure-sensitive adhesive layer formed thereon, as that used in the step (b) of Example 1 was laminated at its pressure-sensitive adhesive layer side on the surface of the first retardation plate side of the composite retardation plate obtained in the step (a), to fabricate a composite optical member comprising the lamination of the polarizing plate/the pressure-sensitive adhesive layer/the first retardation plate/the pressure-sensitive adhesive layer/the second retardation plate/the pressure-sensitive adhesive layer in this order.

This composite optical member was evaluated in light leakage attributed to cracking of the second retardation plate due to an external force, in the same manner as in the step (b1) of Example 1. As a result, light leakage occurred under a load of 600 g.

This composite optical member was also evaluated in light leakage attributed to cracking of the end portions of the second retardation plate due to cutting, in the same manner as in the step (b2) of Example 1. As a result, 28 cross-cut chips each of which had a crack with a length of 500 μm or more at any of the end portions of the four sides of the chip, were found per 100 cross-cut chips.

### Example 4

### (a) Fabrication of Composite Retardation Plate and Evaluation Thereof

In this Example, a composite retardation plate was fabricated by the above-described first transfer method. First, the above-described coating liquid A for primer layer was applied to a retardation plate which was an uniaxially oriented film of a polycarbonate resin [“WRF-S-141” manufactured by TEIJIN CHEMICALS LTD.; in-plane phase difference: 141 nm; i.e., a first retardation plate], and was dried at 80° C. for one minute to form a primer layer having a moisture content of about 30%. Separately, a polyethylene terephthalate film with a thickness of 38 μm, subjected to a mold-release treatment (contact angle of water to the treated surface: 110°) was used as a transfer substrate; and the above-described coating liquid for second retardation plate was applied to the treated surface of the transfer substrate and was dried at 90° C. for 3 minutes to form a second retardation plate consisting of the coating layer. The first retardation plate having the primer layer formed thereon and the second retardation plate formed on the transfer substrate were laminated on each other, using, as joint faces, the primer layer and the second retardation plate. The resulting lamination was dried in an oven for about 10 minutes so that the moisture content of the primer layer could be less than 0.5%. After that, the transfer substrate was peeled from the second retardation plate, and an acrylic pressure-sensitive adhesive (“P-3132 manufactured by LINTEC CO., LTD.) was applied to the surface of the second retardation plate from which the transfer substrate already had been peeled, to obtain a composite retardation plate comprising the lamination of the first retardation plate/the primer layer/the second retardation plate/the pressure-sensitive adhesive layer in this order.

A peeling test was conducted on this composite retardation plate in the same manner as in the step (a1) of Example 1. The pressure-sensitive adhesive layer was broken at 6.4 N during the test. Thus, the adhesion force between the primer layer and the second retardation plate was estimated to be at least 6.4 N. After that, the peeling was continued to find that the pressure-sensitive adhesive layer and the second retardation plate were left to remain on the surface of the soda glass plate, occupying 25% of the laminated area of the glass plate.

A crosshatch test was conducted on this composite retardation plate in the same manner as in the step (a2) of Example 1. As a result, the number of the peeled cross-cut chips was 100/100.

### (b) Fabrication of Composite Optical Member and Evaluation Thereof

The same polarizing plate, “SR062AP6-HC2”, having the pressure-sensitive adhesive layer formed thereon, as that used in the step (b) of Example 1 was laminated on the surface of the first retardation plate side of the composite retardation plate obtained in the step (a), to fabricate a composite optical member comprising the lamination of the polarizing plate/the pressure-sensitive adhesive layer/the first retardation plate/the primer layer/the second retardation plate/the pressure-sensitive adhesive layer in this order.

This composite optical member was evaluated in light leakage attributed to cracking of the second retardation plate due to an external force, in the same manner as in the step (b1) of Example 1. As a result, no light leakage occurred even under a load of 2.0 kg as the limit of loading.

This composite optical member was also evaluated in light leakage attributed to cracking of the end portions of the second retardation plate due to cutting, in the same manner as in the step (b2) of Example 1. As a result, no light leakage occurred in any of the end portions of the four sides of the chip.

### Example 5

### (a) Fabrication of Composite Retardation plate and Evaluation Thereof

In this Example, a composite retardation plate was fabricated by the second transfer method. First, the above-described coating liquid for second retardation plate was applied to a transfer substrate of a polyethylene terephthalate film which was the same one as that used in Example 4, and was then dried under the same conditions as those in Example 4, to form a second retardation plate consisting of the coating layer. An acrylic pressure-sensitive adhesive [“P-3132” manufactured by LINTEC CO., LTD.] was applied to the surface of the second retardation plate to prepare the second retardation plate having the pressure-sensitive adhesive layer formed thereon. Separately, the above-described coating liquid A for primer layer was applied to a retardation plate “WRF-S-141” (as a first retardation plate) which was an uniaxially oriented film of the same polycarbonate resin as used in Example 4, and was dried under the same conditions as in Example 4, to form a primer layer. The transfer substrate was peeled from the second retardation plate having the pressure-sensitive adhesive layer formed thereon, and the exposed surface of the second retardation plate was laminated on the primer layer of the first retardation plate. The resulting lamination was dried in an oven for about 10 minutes so that the moisture content of the primer layer could be less than 0.5%. Thus, a composite retardation plate comprising the lamination of the first retardation plate/the primer layer/the second retardation plate/the pressure-sensitive adhesive layer in this order was obtained.

A peeling test was conducted on this composite retardation plate in the same manner as in the step (a1) of Example 1. The pressure-sensitive adhesive layer was broken at 6.3 N during the test. Thus, the adhesion force between the primer layer and the second retardation plate was estimated to be at least 6.3 N. After that, the peeling was continued to find that the pressure-sensitive adhesive layer and the second retardation plate were left to remain on the surface of the soda glass plate, occupying 6% of the laminated area of the glass plate.

A crosshatch test was conducted on this composite retardation plate in the same manner as in the step (a2) of Example 1. As a result, the number of the peeled cross-cut chips was 100/100.

### (b) Fabrication of Composite Optical Member and Evaluation Thereof

The same polarizing plate, “SR062AP6-HC2”, having the pressure-sensitive adhesive layer formed thereon, as that used in the step (b) of Example 4 was laminated on the surface of the first retardation plate side of the composite retardation plate obtained in the step (a), to fabricate a composite optical member comprising the lamination of the polarizing plate/the pressure-sensitive adhesive layer/the first retardation plate/the primer layer/the second retardation plate/the pressure-sensitive adhesive layer in this order.

This composite optical member was evaluated in light leakage attributed to cracking of the second retardation plate due to an external force, in the same manner as in the step (b1) of Example 1. As a result, no light leakage occurred even under a load of 2.0 kg as the limit of loading.

This composite optical member was also evaluated in light leakage attributed to cracking of the end portions of the second retardation plate due to cutting, in the same manner as in the step (b2) of Example 1. As a result, no light leakage occurred in any of the end portions of the four sides of the chip.

### Example 6

### (a) Fabrication of Composite Retardation Plate and Evaluation Thereof

In this Example, a composite retardation plate was fabricated by the above-described coating method. First, the above-described coating liquid A for primer layer was applied to a retardation plate “WRF-S-141” (as a first retardation plate) which was an uniaxially oriented film of the same polycarbonate resin as used in Example 4, and was dried at 80° C. for about 10 minutes, to form a primer layer having a moisture content of about 0.5%. Next, the above-described coating liquid for second retardation plate was applied to the primer layer, and was then dried at 90° C. for 3 minutes, to form a second retardation plate consisting of the coating layer. An acrylic pressure-sensitive adhesive [“P-3132” manufactured by LINTEC CO., LTD.] was applied to the surface of the second retardation plate to obtain a composite retardation plate comprising the lamination of the first retardation plate/the primer layer/the second retardation plate/the pressure-sensitive adhesive layer in this order.

A crosshatch test was conducted on this composite retardation plate in the same manner as in the step (a2) of Example 1. As a result, the number of the peeled cross-cut chips was 0/100.

### (b) Fabrication of Composite Optical Member and Evaluation Thereof

The same polarizing plate, “SR062AP6-HC2”, having the pressure-sensitive adhesive layer formed thereon, as that used in the step (b) of Example 4 was laminated on the surface of the first retardation plate side of the composite retardation plate obtained in the step (a), to fabricate a composite optical member comprising the lamination of the polarizing plate/the pressure-sensitive adhesive layer/the first retardation plate/the primer layer/the second retardation plate/the pressure-sensitive adhesive layer in this order.

This composite optical member was evaluated in light leakage attributed to cracking of the second retardation plate due to an external force, in the same manner as in the step (b1) of Example 1. As a result, no light leakage occurred even under a load of 2.0 kg as the limit of loading.

This composite optical member was also evaluated in light leakage attributed to cracking of the end portions of the second retardation plate due to cutting, in the same manner as in the step (b2) of Example 1. As a result, no light leakage occurred in any of the end portions of the four sides of the chip.

### Comparative Example 2

### (a) Fabrication of Composite Retardation Plate

The above-described coating liquid for second retardation plate was applied to a transfer substrate of a polyethylene terephthalate film which was the same one as that used in Example 4, and was then dried under the same conditions as those in Example 4, to form a second retardation plate consisting of the coating layer. A retardation plate [“WRF-S-141-P8” manufactured by TEIJIN CHEMICALS LTD.] which was formed of the same material as that constituting each of the first retardation plates used in Examples 4 to 6 and which had the same in-plane phase difference and had a pressure-sensitive adhesive layer formed on its one side, was laminated at its pressure-sensitive adhesive layer side, on the second retardation plate side of the above lamination. The transfer substrate was peeled from the second retardation plate, and an acrylic pressure-sensitive adhesive [“P-3132” manufactured by LINTEC CO., LTD.] was applied to the exposed surface of the second retardation plate to fabricate a composite retardation plate comprising the lamination of the first retardation plate/the pressure-sensitive adhesive layer/the second retardation plate/the pressure-sensitive adhesive layer in this order.

### (b) Fabrication of Composite Optical Member and Evaluation Thereof

The same polarizing plate, “SR062AP6-HC2”, having the pressure-sensitive adhesive layer formed thereon, as that used in the step (b) of Example 4 was laminated on the surface of the first retardation plate side of the composite retardation plate obtained in the step (a), to fabricate a composite optical member comprising the lamination of the polarizing plate/the pressure-sensitive adhesive layer/the first retardation plate/the pressure-sensitive adhesive layer/the second retardation plate/the pressure-sensitive adhesive layer in this order.

This composite optical member was evaluated in light leakage attributed to cracking of the second retardation plate due to an external force, in the same manner as in the step (b1) of Example 1. As a result, light leakage occurred under a load of 700 g.

This composite optical member was also evaluated in light leakage attributed to cracking of the end portions of the second retardation plate due to cutting, in the same manner as in the step (b2) of Example 1. As a result, 17 chips each of which had a crack with a length of 500 μm or more at any of the end portions of the four sides of the chip, were found per 100 cross-cut chips.

Next, Examples using primer layers formed of a coating liquid for primer layer, which had a relatively high solid content, are described below. The coating liquid for primer layer used in the following Examples 7 to 12 was prepared as follows.

[Coating Liquid for Primer Layer Used in Examples 7 to 12] (Hereinafter Referred to as Coating Liquid B for Primer layer)

As the water-soluble epoxy resin, there was used “SUMIREZ RESIN 650(30)” (trade name, an aqueous solution having a solid content of 30%) which is a polyamide epoxy resin manufactured by Sumika Chemtex Co., Ltd.). As the polyvinyl alcohol resin, there was used “KL-506” (trade name) which is a carboxyl group-modified polyvinyl alcohol manufactured by KURARAY CO., LTD. Both the resins were blended in the following composition.

Composition of Coating Liquid B for Primer Layer

| | | |
|---|---|---|
| Water | 100 | parts |
| Polyamide epoxy resin | 7.5 | parts |
| “SUMIRES RESIN 650(30)” | | |
| Polyvinyl alcohol “KL-506” | 15 | parts |

This coating liquid was prepared by mixing water with polyvinyl alcohol “KL-506”, while the water being heated to 100° C., stirring the resulting mixture, cooling the mixture to a room temperature, further mixing the mixture with a polyamide epoxy resin, “SUMIRES RESIN 650(30)”, and stirring the mixture.

### Example 7

In this Example, a composite retardation plate was fabricated, according to the first transfer method employed in Example 1. However, a primer layer was formed, using the above-described coating liquid B for primer layer, and the thickness of the primer layer was a little higher. First, the above-described coating liquid B for primer layer was applied to a retardation plate which was an uniaxially oriented film of a norbornene resin [“CSES430120Z-S-KY” manufactured by Sumitomo Chemical Company Limited; in-plane phase difference: 120 nm; i.e., a first retardation plate], and was dried at 80° C. for one minute to form a primer layer with a thickness of about 2 μm, having a moisture content of about 35%. Separately, a polyethylene terephthalate film with a thickness of 38 μm, subjected to a mold-release treatment (contact angle of water to the treated surface: 110°) was used as a transfer substrate; and the above-described coating liquid for second retardation plate was applied to the treated surface of the transfer substrate and was dried at 90° C. for 3 minutes to form a second retardation plate consisting of the coating layer. The first retardation plate having the primer layer formed thereon and the second retardation plate formed on the transfer substrate were laminated on each other, using, as joint faces, the primer layer and the second retardation plate. The resulting lamination was dried in an oven for about 10 minutes so that the moisture content of the primer layer could be less than 0.5%. After that, the transfer substrate was peeled from the second retardation plate, and an acrylic pressure-sensitive adhesive (“P-3132 manufactured by LINTEC CO., LTD.) was applied to the surface of the second retardation plate from which the transfer substrate already had been peeled, to obtain a composite retardation plate comprising the lamination of the first retardation plate/the primer layer/the second retardation plate/the pressure-sensitive adhesive layer in this order.

The same tests as those conducted in the steps (a1) and (a2) in Example 1 were conducted on this composite retardation plate. The results were similar to those found in Example 1, in both the peeling test and the crosshatch test. The adhesion force between the primer layer and the second retardation plate was estimated to be at least 9.4 N. After the entire peeling test, the pressure-sensitive adhesive layer and the second retardation plate were left to remain on the surface of the soda glass plate, occupying 57% of the laminated area of the glass plate. The number of the peeled cross-cut chips was 100/100.

A composite optical member was fabricated, using this composite retardation plate in the same manner as in the step (b) of Example 1, and was evaluated in the same manners as in the steps (b1) and (b2) of Example 1. The results were similar to those found in Example 1 in light leakage attributed to both of an external force and cutting: that is, no light leakage occurred even under a load of 2.0 kg which was the limit of loading; and no light leakage occurred in any of the end portions of the chip after cutting.

### Example 8

In this Example, a composite retardation plate was fabricated, according to the second transfer method employed in Example 2. However, a primer layer was formed, using the above-described coating liquid B for primer layer, and the thickness of the primer layer was a little higher. First, the above-described coating liquid for second retardation plate was applied to a transfer substrate of a polyethylene terephthalate film which was the same one as that used in Example 7, and was then dried under the same conditions as those in Example 7, to form a second retardation plate consisting of the coating layer. An acrylic pressure-sensitive adhesive [“P-3132” manufactured by LINTEC CO., LTD.] was applied to the surface of the second retardation plate to prepare the second retardation plate having the pressure-sensitive adhesive layer formed thereon. Separately, the above-described coating liquid B for primer layer was applied to a retardation plate “CSES430120Z-S-KY” (as a first retardation plate) which was an uniaxially oriented film of the same norbornene resin as used in Example 7, and was dried under the same conditions as in Example 7, to form a primer layer with a thickness of about 2 μm. The transfer substrate was peeled from the second retardation plate having the pressure-sensitive adhesive layer formed thereon, and the exposed surface of the second retardation plate was laminated on the primer layer of the first retardation plate. The resulting lamination was dried in an oven for about 10 minutes so that the moisture content of the primer layer could be less than 0.5%. Thus, a composite retardation plate comprising the lamination of the first retardation plate/the primer layer/the second retardation plate/the pressure-sensitive adhesive layer in this order was obtained.

The same tests as those conducted in the steps (a1) and (a2) in Example 1 were conducted on this composite retardation plate. The results were similar to those found in Example 2, in both the peeling test and the crosshatch test. The adhesion force between the primer layer and the second retardation plate was estimated to be at least 9.9 N. After the entire peeling test, the pressure-sensitive adhesive layer and the second retardation plate were left to remain on the surface of the soda glass plate, occupying 25% of the laminated area of the glass plate. The number of the peeled cross-cut chips was 100/100.

A composite optical member was fabricated, using this composite retardation plate in the same manner as in the step (b) of Example 2, and was evaluated in the same manners. The results were similar to those found in Example 2 in light leakage attributed to both of an external force and cutting: that is, no light leakage occurred even under a load of 2.0 kg which was the limit of loading; and no light leakage occurred in any of the end portions of the chip after cutting.

### Example 9

In this Example, a composite retardation plate was fabricated according to the coating method employed in Example 3. However, a primer layer was formed, using the above-described coating liquid B for primer layer, and the thickness of the primer layer was a little higher. First, the above-described coating liquid B for primer layer was applied to a retardation plate “CSES430120Z-S-KY” (as a first retardation plate) which was an uniaxially oriented film of the same norbornene resin as used in Example 7, and was dried at 80° C. for about 10 minutes, so that a primer layer could have a thickness of about 2 μm after dried, having a moisture content of about 0.5%. Next, the above-described coating liquid for second retardation plate was applied to the primer layer, and was then dried at 90° C. for 3 minutes, to form a second retardation plate consisting of the coating layer. An acrylic pressure-sensitive adhesive [“P-3132” manufactured by LINTEC CO., LTD.] was applied to the surface of the second retardation plate to obtain a composite retardation plate comprising the lamination of the first retardation plate/the primer layer/the second retardation plate/the pressure-sensitive adhesive layer in this order.

The same crosshatch test as in the step (a2) of Example 1 was conducted on this composite retardation plate. The result was similar to that found in Example 3: that is, the number of the peeled cross-cut chips was 0/100.

A composite optical member was fabricated, using this composite retardation plate in the same manner as in the step (b) of Example 3, and was evaluated in the same manners. The results were similar to those found in Example 3 in light leakage attributed to both of an external force and cutting: that is, no light leakage occurred even under a load of 2.0 kg which was the limit of loading; and no light leakage occurred in any of the end portions of the chip after cutting.

### Example 10

In this Example, a composite retardation plate was fabricated, according to the first transfer method employed in Example 4. However, a primer layer was formed, using the above-described coating liquid B for primer layer, and the thickness of the primer layer was a little higher.

First, the above-described coating liquid B for primer layer was applied to a retardation plate which was an uniaxially oriented film of the same polycarbonate resin as that used in Example 4, “WRF-S-141” (i.e., a first retardation plate), and was dried at 80° C. for one minute, so that the primer layer could have a thickness of about 2 μm after dried, having a moisture content of about 30%. Separately, a polyethylene terephthalate film with a thickness of 38 μm, subjected to a mold-release treatment (contact angle of water to the treated surface: 110°) was used as a transfer substrate; and the above-described coating liquid for second retardation plate was applied to the treated surface of the transfer substrate and was dried at 90° C. for 3 minutes to form a second retardation plate consisting of the coating layer. The first retardation plate having the primer layer formed thereon and the second retardation plate formed on the transfer substrate were laminated on each other, using, as joint faces, the primer layer and the second retardation plate. The resulting lamination was dried in an oven for about 10 minutes so that the moisture content of the primer layer could be less than 0.5%. After that, the transfer substrate was peeled from the second retardation plate, and an acrylic pressure-sensitive adhesive (“P-3132 manufactured by LINTEC CO., LTD.) was applied to the exposed surface of the second retardation plate from which the transfer substrate already had been peeled, to obtain a composite retardation plate comprising the lamination of the first retardation plate/the primer layer/the second retardation plate/the pressure-sensitive adhesive layer in this order.

The same tests as those conducted in the steps (a1) and (a2) in Example 1 were conducted on this composite retardation plate. The results were similar to those found in Example 4, in both the peeling test and the crosshatch test. The adhesion force between the primer layer and the second retardation plate was estimated to be at least 6.4 N. After the entire peeling test, the pressure-sensitive adhesive layer and the second retardation plate were left to remain on the surface of the soda glass plate, occupying 25% of the laminated area of the glass plate. The number of the peeled cross-cut chips in the crosshatch test was 100/100.

A composite optical member was fabricated, using this composite retardation plate in the same manner as in the step (b) of Example 4, and was evaluated in the same manners. The results were similar to those found in Example 4 in light leakage attributed to both of an external force and cutting: that is, no light leakage occurred even under a load of 2.0 kg which was the limit of loading; and no light leakage occurred in any of the end portions of the chip after cutting.

### Example 11

In this Example, a composite retardation plate was fabricated, according to the second transfer method employed in Example 5. However, a primer layer was formed, using the above-described coating liquid B for primer layer, and the thickness of the primer layer was a little higher. First, the above-described coating liquid for second retardation plate was applied to a transfer substrate of a polyethylene terephthalate film which was the same one as that used in Example 10 and was then dried under the same conditions as those in Example 10, to form a second retardation plate consisting of the coating layer. An acrylic pressure-sensitive adhesive [“P-3132” manufactured by LINTEC CO., LTD.] was applied to the surface of the second retardation plate to prepare the second retardation plate having the pressure-sensitive adhesive layer formed thereon. Separately, the above-described coating liquid B for primer layer was applied to a retardation plate “WRF-S-141” (as a first retardation plate) which was an uniaxially oriented film of the same polycarbonate resin as used in Example 10, and was dried under the same conditions as in Example 10, to form a primer layer with a thickness of about 2 μm after dried. The transfer substrate was peeled from the second retardation plate having the pressure-sensitive adhesive layer formed thereon, and the exposed surface of the second retardation plate was laminated on the primer layer of the first retardation plate. The resulting lamination was dried in an oven for about 10 minutes so that the moisture content of the primer layer could be less than 0.5%. Thus, a composite retardation plate comprising the lamination of the first retardation plate/the primer layer/the second retardation plate/the pressure-sensitive adhesive layer in this order was obtained.

The same tests as those conducted in the steps (a1) and (a2) in Example 1 were conducted on this composite retardation plate. The results were similar to those found in Example 5, in both the peeling test and the crosshatch test. The adhesion force between the primer layer and the second retardation plate was estimated to be at least 6.3 N. After the entire peeling test, the pressure-sensitive adhesive layer and the second retardation plate were left to remain on the surface of the soda glass plate, occupying 6% of the laminated area of the glass plate. The number of the peeled cross-cut chips in the crosshatch test was 100/100.

A composite optical member was fabricated, using this composite retardation plate in the same manner as in the step (b) of Example 5, and was evaluated in the same manners. The results were similar to those found in Example 5 in light leakage attributed to both of an external force and cutting: that is, no light leakage occurred even under a load of 2.0 kg which was the limit of loading; and no light leakage occurred in any of the end portions of the chip after cutting.

### Example 12

In this Example, a composite retardation plate was fabricated according to the coating method employed in Example 6. However, a primer layer was formed, using the above-described coating liquid B for primer layer, and the thickness of the primer layer was a little higher. First, the above-described coating liquid B for primer layer was applied to a retardation plate “WRF-S-141” (as a first retardation plate) which was an uniaxially oriented film of the same polycarbonate resin as used in Example 10, and was dried at 80° C. for about 10 minutes, to form a primer layer with a thickness of about 2 μm after dried, having a moisture content of about 0.5%. Next, the above-described coating liquid for second retardation plate was applied to the primer layer, and was then dried at 90° C. for 3 minutes, to form a second retardation plate consisting of the coating layer. An acrylic pressure-sensitive adhesive [“P-3132” manufactured by LINTEC CO., LTD.] was applied to the surface of the second retardation plate to obtain a composite retardation plate comprising the lamination of the first retardation plate/the primer layer/the second retardation plate/the pressure-sensitive adhesive layer in this order.

The same crosshatch test as in the step (a2) of Example 1 was conducted on this composite retardation plate. The result was similar to that found in Example 6: that is, the number of the peeled cross-cut chips in the crosshatch test was 0/100.

A composite optical member was fabricated, using this composite retardation plate, in the same manner as in the step (b) of Example 6, and was evaluated in the same manners. The results were similar to those found in Example 6 in light leakage attributed to both of an external force and cutting: that is, no light leakage occurred even under a load of 2.0 kg. which was the limit of loading; and no light leakage occurred in any of the end portions of the chip after cutting.

Any of the composite retardation plates of the present invention can effectively suppress light leakage attributed to cracking of the second retardation plate, liable to occur due to an external physical force, when laminated on a liquid crystal cell, because the first retardation plate and the second retardation plate are laminated on each other through the primer layer. Thus, it becomes possible for the resultant liquid crystal display to obtain a sufficient display condition. Accordingly, it becomes possible to suppress light leakage from a liquid crystal display comprising a composite optical member which is fabricated by combining this composite retardation plate with an optical layer having other optical function, such as a polarizing plate, so that such a liquid crystal display obtains an excellent display condition.

1. A composite retardation plate comprising a first retardation plate, a primer layer, a second retardation plate and a pressure-sensitive adhesive layer which are laminated in this order, wherein the second retardation plate is obtained by evaporating an organic solvent from a coating liquid containing an organic modified clay complex and a binder resin in an organic solvent.

2. The composite retardation plate of claim 1, wherein said first retardation plate comprises an in-plane oriented transparent resin film.

3. The composite retardation plate of claim 1, wherein said primer layer comprises a transparent resin.

4. The composite retardation plate of claim 3, wherein said primer layer comprises an epoxy resin.

5. The composite retardation plate of claim 3, wherein said primer layer is formed of a composition comprising a water-soluble epoxy resin and a polyvinyl alcohol resin.

6. The composite retardation plate of claim 5, wherein said water-soluble epoxy resin is a polyamide epoxy resin.

7. A process for producing a composite retardation plate, comprising
a primer layer-forming step in which a primer layer is formed on the surface of a first retardation plate;
a coating layer-forming step in which a coating liquid containing an organic modified clay complex and a binder resin in an organic solvent is applied to a transfer substrate to form a coating layer thereon, and the solvent is removed from the coating layer to obtain a second retardation plate;
a laminating step in which the primer layer obtained in the primer layer-forming step and the second retardation plate obtained in the coating layer-forming step are laminated on each other;
a transfer substrate-peeling step in which the transfer substrate is peeled from the second retardation plate; and
a pressure-sensitive adhesive layer-forming step in which a pressure-sensitive adhesive layer is formed on the surface of the second retardation plate,
wherein, at least, the primer layer-forming step and the coating layer-forming step are conducted prior to other steps, and
wherein the respective steps are conducted so as to obtain a layer structure consisting of the first retardation plate/the primer layer/the second retardation plate/the pressure-sensitive adhesive layer.

8. The process of claim 7, wherein the primer layer-forming step and the coating layer-forming step are conducted, followed by the laminating step, the transfer substrate-peeling step and the pressure-sensitive adhesive layer-forming step in this order.

9. The process of claim 7, wherein the primer layer-forming step and the coating layer-forming step are conducted, followed by the pressure-sensitive adhesive layer-forming step, the transfer substrate-peeling step and the laminating step in this order.

10. A process for producing a composite retardation plate, comprising:
a primer layer-forming step in which a primer layer is formed on the surface of a first retardation plate;
a coating layer-forming step in which a coating liquid containing an organic modified clay complex and a binder resin in an organic solvent is applied to the surface of the primer layer to form a coating layer thereon, and the solvent is removed from the coating layer to obtain a second retardation plate; and
a pressure-sensitive adhesive layer-forming step in which a pressure-sensitive adhesive layer is formed on the surface of the second retardation plate,
wherein these steps are conducted in this order so as to obtain a layer structure consisting of the first retardation plate/the primer layer/the second retardation plate/the pressure-sensitive adhesive layer.

11. The process of claim 7, wherein the coating liquid containing the organic modified clay complex and the binder resin in the organic solvent has a chlorine content of 2,000 ppm or less.

12. The process of claim 7, wherein the coating liquid containing the organic modified clay complex and the binder resin in the organic solvent has a water content of from 0.15 to 0.35% by weight, measured with a Karl Fischer's moisture meter.

13. A composite optical member fabricated by laminating an optical layer having other optical function, on the composite retardation plate as defined in claim 1.

14. The composite optical member of claim 13, wherein said optical layer includes, at least, a polarizing plate.

15. The composite optical member of claim 14, wherein said polarizing plate is laminated on the first retardation plate side of the composite retardation plate.

16. A liquid crystal display assembled by disposing the composite optical member as defined in claim 13, on at least one side of a liquid crystal cell.
